(19) United States
(12) Patent Application Publication
(10) Pub. No.: US 2023/0048349 A1
(43) Pub. Date: Feb. 16, 2023

(54) RECIRCULATING AQUACULTURE SYSTEM AND METHODS THEREOF

(71) Applicant: THE TEXAS A&M UNIVERSITY SYSTEM, College Station, TX (US)

(72) Inventor: Kung-Hui CHU, College Station, TX (US)

(21) Appl. No.: 17/879,326

(22) Filed: Aug. 2, 2022

Related U.S. Application Data
(60) Provisional application No. 63/228,291, filed on Aug. 2, 2021.

(51) Int. Cl. C02F 3/34; C02F 3/10; A23K 50/80; A23K 10/18

(52) U.S. Cl. CPC C02F 3/341; C02F 3/107; A23K 50/80; A23K 10/18; C02F 2101/30

(57) ABSTRACT

The present disclosure provides a recirculating aquaculture system comprising a) a wastewater treatment system and b) a polyhydroxyalkanoate (PHA) production system. In particular, poly(3-hydroxybutyrate) (PHB) can be utilized as the PHA in such a system. Methods of treating wastewater for reuse by contacting the wastewater with one or more zeolites to remove material from the wastewater and reusing the treated wastewater are also provided as well as methods of producing a PHA such as PHB from organic waste. Moreover, food compositions comprising a PHA biomass as well as associated methods are also provided.

### CROSS-REFERENCE TO RELATED APPLICATIONS

This application claims the benefit under 35 USC § 119(e) of U.S. Provisional Application Ser. No. 63/228,291, filed on Aug. 2, 2021, the entire disclosure of which is incorporated herein by reference.

### GOVERNMENT RIGHTS

This invention was made with government support under 2019-70007-30370 awarded by U.S. Department of Agriculture/National Institute of Food and Agriculture. The government has certain rights in the invention.

### BACKGROUND AND SUMMARY OF THE INVENTION

The field of aquaculture represents the fastest growing food production sector with an annual growth rate of 8%. In particular, aquaculture has supplied more than half of the total fish consumed by humans in recent years. However, current aquaculture practices—including both outdoor and indoor cultivation systems—are not sustainable due to problems including poor waste management, high feed cost, and undesirable use of antibiotics. Therefore, there exists a need to develop sustainable cultivation systems to address the challenges posed by current aquaculture practices.

Accordingly, the present disclosure provides a sustainable cultivation system as well as associated methods and compositions thereof. Generally, the present disclosure provides a novel system including a recirculation aquaculture system (RAS) utilizing the beneficial effects of polyhydroxyalkanoates. For instance, the polyhydroxyalkanoates known as poly(3-hydroxybutyrate) (PHB) can be utilized in this nature, in partivalar in a recirculation aquaculture system referred to herein as “RAS-PHB”. The disclosed system is capable of i) effectively treating wastewater for reuse and ii) producing PHB from organic waste.

Furthermore, the present disclosure provides a food composition comprising a biomass that includes high levels of polyhydroxyalkanoates such as PHB. For instance, a PHB-rich food composition can be used as a protein-rich and immune-stimulating aquacultural feed, thus reducing the requirement for addition of antibiotics. Importantly, PHB-rich biomass can be produced from various agricultural and/or industrial wastewaters, for instance by culturing organic waste with a Zobellella denitrificans (ZD) strain to produce the PHB under non-sterile conditions.

As detailed in the present disclosure, several advantages can be realized using the described system, methods, and compositions. First, the RAS-PHB system can reduce the overall cost for waste/wastewater management. Second, the system can be utilized to reduce aquaculture feed cost by replacing conventional feed with the PHB-rich biomass. Furthermore, the food compositions produced using the RAS-PHB system can avoid unnecessary use of antibiotics that are problematic in any food production sector.

Other objects, features and advantages of the present disclosure will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1A shows a conventional Recirculating Aquaculture System (RAS) and FIG. 1B shows the RAS-PHB system of the present disclosure, allowing treatment of aquaculture wastewater and production of PHB-rich biomass for fish feed.

FIG. 2 shows change in NH₄⁺—N concentration with time after adsorption by natural zeolite under different initial NH₄⁺—N concentrations.

FIG. 3 shows different amounts of NH₄⁺—N were desorbed from the spent zeolites, based on 1.25 of zeolites, in different extraction solutions. The total mass of NH₄⁺—N adsorbed in spent zeolites was 9.25 mg.

FIG. 4 shows concentration of released NH₄⁺—N from ammonium-laden zeolite using various desorption solutions.

FIG. 5 shows desorption (%) from each cycle after extraction of ammonium-laden zeolite with 3% NaCl. NH₄⁺—N concentration detected in the extract after each cycle was shown on the top of the bar.

FIG. 6 shows Z. denitrificans ZD1 cultivation in N-free MSM, glycerol (5 g/L), and one of the three extracts obtained from spent zeolite after three cycles of 3% NaCl desorption.

FIG. 7A shows growth curves of Z. denitrificans ZD1 in N-free MSM with 3% NaCl-desorption solution (Extract-AW) from spent zeolite obtained from aquaculture wastewater (AW), AW before adsorption (positive control), and zeolite-treated AW (negative control). Glycerol was supplied in all cultivations as a carbon source, and FIG. 7B shows growth curves and biomass characterization of Z. denitrificans ZD1 grown in glycerol and CWW.

FIG. 8 shows changes in pH during the growth of Z. denitrificans ZD1 in agro-industrial wastes/wastewaters, glycerol and CWW.

FIG. 9A shows harvesting efficiency (%) of Z. denitrificans ZD1 biomass under various pH values and coagulant dosages of medium M_{w} chitosan, FIG. 9B shows harvesting efficiency (%) of Z. denitrificans ZD1 biomass under various pH values and coagulant dosages of low M_{w} chitosan, and FIG. 9C shows harvesting efficiency (%) of Z. denitrificans ZD1 biomass under various pH values and coagulant dosages of FeCl₃. The dashed lines represent the harvesting efficiency of the control (gravitational settling of cells without adding coagulants). FIG. 9D shows effects of salinity on Z. denitrificans ZD1 biomass harvesting efficiency using various dosages of medium M_{w} chitosan at pH of 9.

FIG. 10A shows survival of Artemia challenged with various concentrations of live V. campbellii (106-108 cells/ml), and FIG. 10B shows representative microscopic images of Artemia after four days of challenge. The bars represent ranges of duplicate samples.

FIG. 11A, FIG. 11B, FIG. 11C, and FIG. 11D show the growth curves of Gram-negative strain V. campbellii incubated in liquid media with various concentrations of 3-hydroxybutyrate (3-HB), butyrate, chitosan oligosaccharides (COS), and Mixtures 1-4 of 3-HB+COS. FIG. 11E, FIG. 11F, FIG. 11G, and FIG. 11H show the growth curves of Gram-negative strain A. hydrophila incubated in liquid media with various concentrations of 3-hydroxybutyrate (3-HB), butyrate, chitosan oligosaccharides (COS), and Mixtures 1-4 of 3-HB+COS. FIG. 11I, FIG. 11J, FIG. 11K, and FIG. 11L show the growth curves of Gram-negative strain E. coli incubated in liquid media with various concentrations of 3-hydroxybutyrate (3-HB), butyrate, chitosan oligosaccharides (COS), and Mixtures 1-4 of 3-HB+COS. FIG. 11M, FIG. 11N, FIG. 11O, and FIG. 11P show the growth curves of Gram-positive strain S. agalactiae incubated in liquid media with various concentrations of 3-hydroxybutyrate (3-HB), butyrate, chitosan oligosaccharides (COS), and Mixtures 1-4 of 3-HB+COS. FIG. 11Q, FIG. 11R, FIG. 11S, and FIG. 11T show the growth curves of Gram-positive strain B. megaterium incubated in liquid media with various concentrations of 3-hydroxybutyrate (3-HB), butyrate, chitosan oligosaccharides (COS), and Mixtures 1-4 of 3-HB+COS. FIG. 11U, FIG. 11V, FIG. 11W, and FIG. 11X show the growth curves of Gram-positive strain R. jostii RHA1 incubated in liquid media with various concentrations of 3-hydroxybutyrate (3-HB), butyrate, chitosan oligosaccharides (COS), and Mixtures 1-4 of 3-HB+COS.

FIG. 12A shows the survival of starved Artemia fed with Poly(3-hydroxybutyrate) (PHB), chitosan, and PHB+chitosan, FIG. 12B shows the survival of starved Artemia fed with Chitosan- and non-chitosan-harvested PHB-rich ZD1 biomass (CP-ZD1 and P-ZD1), and FIG. 12C shows representative microscopic images of Artemia after five days of different feeds.

FIG. 13A shows the survival rates of Vibrio-challenged Artemia supplemented with Poly(3-hydroxybutyrate) (PHB), chitosan, and PHB+chitosan, and FIG. 13B shows the survival rates of Vibrio-challenged Artemia supplemented with Chitosan- and non-chitosan-harvested PHB-rich ZD1 biomass (CP-ZD1 and P-ZD1).

FIG. 14A shows colony formation of V. campbellii in LB agar after 12 hours of incubation at room temperature (15-20° C.) or 30° C., and FIG. 14B shows colony formation of V. campbellii in LB agar after 36 hours of incubation at room temperature (15-20° C.) or 30° C.

FIG. 15A shows relative expression of immune-related genes hsp70 in Vibrio-challenged Artemia supplemented with different treatments, FIG. 15B shows relative expression of immune-related genes fin in Vibrio-challenged Artemia supplemented with different treatments, and FIG. 15C shows relative expression of immune-related genes pxn in Vibrio-challenged Artemia supplemented with different treatments.

FIG. 16A shows relative abundance of genus level Gram-positive bacterial populations (>1% within at least one sample of the five samples), and FIG. 16B shows relative abundance of all G-associated order-level bacterial populations.

FIG. 17 shows relative abundance of 16 Bacillus spp. (>1% within at least one sample of the five samples) associated ASV level sequences.

FIG. 18 shows phylogenetic tree of 16 Bacillus spp. relevant ASVs and closely associated known Bacillus spp.

FIG. 19A shows heatmap of predicted PHB degradation relevant genes by Tax4fun2, and FIG. 19B shows heatmap of predicted chitosan degradation relevant genes by Tax4fun2.

FIG. 20A shows degradation pathways with specific enzymes of Poly(3-hydroxybutyrate) (PHB), and FIG. 20B shows degradation pathways with specific enzymes of Chitin and chitosan.

FIG. 21 shows Concentrations and relative abundance determined by qPCR of Vibrio spp. in Artemia samples fed with different treatments in relevant to total bacteria based on 16S rRNA.

FIG. 22A shows growth of ZD1 in different concentrations of banana peels (BP), FIG. 22B shows growth of ZD1 in different concentrations of orange peels (OP), and FIG. 22C shows growth of ZD1 in different concentrations of anchovy fishmeal wastewater (AFWW).

FIG. 23A shows growth curves and final pH values of ZD1 grown on different pure organic compounds such as sugars (glucose, fructose, sucrose, and xylose), glycerol, and citric acid and FIG. 23B shows growth curves and final pH values of ZD1 grown on different pure organic compounds such as SCFAs (acetate, propionate, butyrate, and valerate) and MCFAs (hexanoate and octanoate).

FIG. 24 shows growth curves and final pH values of ZD1 grown on different agro-industrial wastes/wastewaters such as sugary waste slurry (SWS), cheese whey wastewater (CWW), synthetic crude glycerol (SCG), high-strength wastewater (HSSW), food waste fermentation liquid (FWFL), banana peels (BP), orange peels (OP), and anchovy fishmeal wastewater (AFWW).

FIG. 25A1-25A4 shows the growth curves of aquaculture pathogen, gram-negative V. campbellii, FIG. 25B1-25B4 shows the growth curves of aquaculture pathogen, gram-negative A. hydrophila, and FIG. 25C1-25C4 shows the growth curves of aquaculture pathogen, gram-positive S. agalactiae incubated in liquid media with 5-125 mM of SCFAs (C-4 butyrate and C-5 valerate) and MCFAs (C-6 hexanoate and C-8 octanoate). Strains cultivated without PHA intermediates were used as controls. The error bars represent ranges of duplicates. The inset tables report the MICs and IC50 of different fatty acids against the pathogens. ^{a}MIC was determined by taking regression through the highest optical densities at different compound concentrations. ^{b}IC₅₀ is estimated by taking regression through % inhibition efficiencies calculated to fit the 4-parameter logistic model. ^{c}<symbol was provided when total inhibition was reached within low tested concentrations. ^{d}N.A.=not applicable (strains have already exhibited full inhibition at the lowest compound concentration).

FIG. 26 shows the biplot derived from principal component analysis (PCA) of minimum inhibitory concentrations (MICs) of fatty acids (butyrate, valerate, hexanoate, and octanoate) against common aquaculture pathogens.

FIG. 27A shows survival of starved Artemia fed with SCFAs (butyrate and valerate) and MCFAs (hexanoate and octanoate), FIG. 27B shows survival of starved Artemia fed with Crystalline PHA (PHB, PHB:9% HV, and PHB:2.3% HV:4.1% HH), and FIG. 27C shows survival of starved Artemia fed with Amorphous SCL-PHA (PHB-rich ZD1 and PHV-rich ZD1) and amorphous MCL-PHA (PHH-rich P. oleovorans and PHO-rich P. oleovorans). Starved (unfed) Artemia and yeast-fed Artemia were used as negative and positive controls, respectively. The error bars represent the standard deviations of triplicate samples.

FIG. 28 shows survival rates of Vibrio-challenged Artemia supplemented with SCFAs (butyrate and valerate), MCFAs (hexanoate and octanoate), crystalline PHA (PHB, PHB:9% HV, and PHB:2.3% HV:4.1% HH), amorphous SCL-PHA (PHB-rich ZD1 and PHV-rich ZD1), and amorphous MCL-PHA (PHH-rich P. oleovorans and PHO-rich P. oleovorans). Unchallenged and Vibrio-challenged Artemia (unsupplemented) were used as negative and positive controls, respectively. Error bars represent standard deviations of triplicate samples.

### DETAILED DESCRIPTION

Various embodiments of the invention are described herein as follows. In an illustrative aspect, a recirculating aquaculture system is provided. The recirculating aquaculture system comprises a) a wastewater treatment system and b) a polyhydroxyalkanoate (PHA) production system. Polyhydroxyalkanoates (PHAs) are generally known in the art as polyesters that can be produced by microorganisms. In an embodiment, the PHA comprises short chain-length (SCL) hydroxyl fatty acids. Generally, SCL can be characterized as those including repeating units between 3-5 carbon atoms in length. In an embodiment, the SCL comprise repeating units between 3-5 carbon atoms in length. In an embodiment, the SCL comprise repeating units selected from the group consisting of 3 carbon atoms in length, 4 carbon atoms in length, 5 carbon atoms in length, and any combination thereof.

In an embodiment, the PHA comprises medium chain-length (MCL) hydroxyl fatty acids. Generally, MCL can be characterized as those including repeating units between 6-14 carbon atoms in length. In an embodiment, the MCL comprise repeating units between 6-14 carbon atoms in length. In an embodiment, the MCL comprise repeating units selected from the group consisting of 6 carbon atoms in length, 7 carbon atoms in length, 8 carbon atoms in length, 9 carbon atoms in length, 10 carbon atoms in length, 11 carbon atoms in length, 12 carbon atoms in length, 13 carbon atoms in length, 14 carbon atoms in length, and any combination thereof. In an embodiment, the PHA comprises repeating units of a SCL hydroxyl fatty acid, a MCL hydroxyl fatty acid, or a combination thereof.

In an embodiment, the PHA is poly(3-hydroxybutyrate) (PHB). In an embodiment, the PHA is polyhydroxyhexanoate (PHH). In an embodiment, the PHA is polyhydroxyoctanoate (PHO).

In an embodiment, the wastewater treatment system is configured for contacting wastewater with one or more zeolites to remove material from the wastewater and reusing the treated wastewater. Zeolites are generally known in the art to be microporous, aluminosilicate minerals that are capable of use as commercial adsorbents and catalysts.

In an embodiment, the zeolites are present in media. In an embodiment, the removed material comprises nitrogen. In an embodiment, the removed material comprises nitrate. In an embodiment, the removed material comprises ammonia. In an embodiment, the zeolite adsorbs the removed material. In an embodiment, the removed material is subsequently released from the zeolite.

In an embodiment, the PHA production system comprises combining i) organic waste, ii) wastewater, or iii) a combination of both with a bacterial strain. In an embodiment, the bacterial strain is a Zobellella denitrificans ZD1 strain. In an embodiment, the Zobellella denitrificans ZD1 strain is cultured under salt conditions.

In an embodiment, the cultured ZD1 strain produces the PHA. In an embodiment, the PHA is PHB. In an embodiment, the PHA comprises repeating units of a SCL hydroxyl fatty acid, a MCL hydroxyl fatty acid, or a combination thereof. In an embodiment, the PHA comprises SCL hydroxyl fatty acids. In an embodiment, the PHA comprises MCL hydroxyl fatty acids. In an embodiment, the cultured ZD1 strain comprising the PHA is a biomass.

In an embodiment, the bacterial strain is a Pseudomonas oleovorans strain. In an embodiment, the Pseudomonas oleovorans strain is cultured under salt conditions. In an embodiment, the cultured Pseudomonas oleovorans strain produces the PHA. In an embodiment, the PHA is PHB. In an embodiment, the PHA comprises repeating units of a SCL hydroxyl fatty acid, a MCL hydroxyl fatty acid, or a combination thereof. In an embodiment, the PHA comprises SCL hydroxyl fatty acids. In an embodiment, the PHA comprises MCL hydroxyl fatty acids. In an embodiment, the cultured Pseudomonas oleovorans strain comprising the PHA is a biomass.

In an embodiment, the organic waste is selected from the group consisting of wastewater, glycerol, activated sludge, and any combination thereof. In an embodiment, the organic waste is provided by the wastewater. In an embodiment, the wastewater comprises saline. In an embodiment, the wastewater does not comprise saline.

In an embodiment, the organic waste is glycerol. In an embodiment, the glycerol is crude glycerol. In an embodiment, the glycerol is a byproduct of biodiesel production. In an embodiment, organic waste is activated sludge.

In an embodiment, the culturing is performed in a bioreactor. In an embodiment, the culturing is performed under non-sterile conditions. In an embodiment, the culturing is performed under increased salt conditions. In an embodiment, the increased salt conditions are provided by sodium chloride. In an embodiment, the culturing is performed under increased nitrate-nitrogen conditions.

In an embodiment, the method further comprises a step of harvesting the cultured bacterial strain comprising PHA via chitosan. In an embodiment, the bacterial strain is a Zobellella denitrificans ZD1 strain. In an embodiment, the bacterial strain is a Pseudomonas oleovorans strain. In an embodiment, the PHA is PHB. In an embodiment, the PHA comprises repeating units of a SCL hydroxyl fatty acid, a MCL hydroxyl fatty acid, or a combination thereof. In an embodiment, the PHA comprises SCL hydroxyl fatty acids. In an embodiment, the PHA comprises MCL hydroxyl fatty acids.

In an embodiment, the culturing comprises addition of a second carbon source. In an embodiment, the second carbon source comprises an agro-wastewater. In an embodiment, the second carbon source comprises an industrial wastewater. In an embodiment, the second carbon source comprises an agro-industrial wastewater.

In an embodiment, the method further comprises a step of recovering the PHA from the bacterial strain. In an embodiment, the bacterial strain is a Zobellella denitrificans ZD1 strain. In an embodiment, the bacterial strain is a Pseudomonas oleovorans strain. In an embodiment, the PHA is PHB. In an embodiment, the PHA comprises repeating units of a SCL hydroxyl fatty acid, a MCL hydroxyl fatty acid, or a combination thereof. In an embodiment, the PHA comprises SCL hydroxyl fatty acids. In an embodiment, the PHA comprises MCL hydroxyl fatty acids.

In an embodiment, the step of recovering comprises addition of a natural coagulant to the culture of the bacterial strain. In an embodiment, the natural coagulant is chitosan. In an embodiment, the natural coagulant is added to media of the culture. In an embodiment, the step of recovering comprises recovering a bacterial biomass.

In an illustrative aspect, a method of treating wastewater for reuse is provided. The method comprises the step of contacting the wastewater with one or more zeolites to remove material from the wastewater and reusing the treated wastewater.

In an embodiment, the zeolites are present in media. In an embodiment, the removed material comprises nitrogen. In an embodiment, the removed material comprises ammonia. In an embodiment, the zeolite adsorbs the removed material.

In an embodiment, the removed material is subsequently released from the zeolite. In an embodiment, the wastewater is treated with light. In an embodiment, the light is ultraviolet light.

In an embodiment, the removed material is utilized via culturing a Zobellella denitrificans ZD1 strain. In an embodiment, the ZD1 strain produces a polyhydroxyalkanoate (PHA). In an embodiment, the PHA is PHB. In an embodiment, the PHA comprises repeating units of a SCL hydroxyl fatty acid, a MCL hydroxyl fatty acid, or a combination thereof. In an embodiment, the PHA comprises SCL hydroxyl fatty acids. In an embodiment, the PHA comprises MCL hydroxyl fatty acids.

In an embodiment, the removed material is utilized via culturing a Pseudomonas oleovorans strain. In an embodiment, the Pseudomonas oleovorans strain produces a PHA. In an embodiment, the PHA is PHB. In an embodiment, the PHA comprises repeating units of a SCL hydroxyl fatty acid, a MCL hydroxyl fatty acid, or a combination thereof. In an embodiment, the PHA comprises SCL hydroxyl fatty acids. In an embodiment, the PHA comprises MCL hydroxyl fatty acids.

In an illustrative aspect, a method of producing a polyhydroxyalkanoate (PHA) from organic waste is provided. The method comprises the step of combining the organic waste with a bacterial strain and culturing the bacterial strain under salt conditions, In an embodiment, the cultured bacterial strain produces the PHA.

In an embodiment, the PHA is poly(3-hydroxybutyrate) (PHB). In an embodiment, the PHA comprises repeating units of a SCL hydroxyl fatty acid, a MCL hydroxyl fatty acid, or a combination thereof. In an embodiment, the PHA comprises SCL hydroxyl fatty acids. In an embodiment, the PHA comprises MCL hydroxyl fatty acids.

In an embodiment, the bacterial strain is a Zobellella denitrificans ZD1 strain. In an embodiment, the bacterial strain is a Pseudomonas oleovorans strain.

In an embodiment, the organic waste is selected from the group consisting of wastewater, glycerol, activated sludge, and any combination thereof. In an embodiment, the organic waste comprises wastewater. In an embodiment, the wastewater comprises saline. In an embodiment, the wastewater does not comprise saline. In an embodiment, the organic waste is glycerol. In an embodiment, the glycerol is crude glycerol. In an embodiment, the glycerol is a byproduct of biodiesel production. In an embodiment, organic waste is activated sludge.

In an embodiment, the culturing is performed in a bioreactor. In an embodiment, the culturing is performed under non-sterile conditions. In an embodiment, the culturing is performed under increased salt conditions. In an embodiment, the increased salt conditions are provided by sodium chloride. In an embodiment, the culturing is performed under increased nitrate-nitrogen conditions.

In an embodiment, the cultured bacterial strain comprises PHA. In an embodiment, the PHA is PHB. In an embodiment, the PHA comprises repeating units of a SCL hydroxyl fatty acid, a MCL hydroxyl fatty acid, or a combination thereof. In an embodiment, the PHA comprises SCL hydroxyl fatty acids. In an embodiment, the PHA comprises MCL hydroxyl fatty acids. In an embodiment, the cultured bacterial strain comprising PHA is a biomass.

In an embodiment, the method further comprises a step of harvesting the cultured bacterial strain comprising PHA via chitosan. In an embodiment, the bacterial strain is a Zobellella denitrificans ZD1 strain. In an embodiment, the bacterial strain is a Pseudomonas oleovorans strain.

In an embodiment, the PHA is PHB. In an embodiment, the PHA comprises repeating units of a SCL hydroxyl fatty acid, a MCL hydroxyl fatty acid, or a combination thereof. In an embodiment, the PHA comprises SCL hydroxyl fatty acids. In an embodiment, the PHA comprises MCL hydroxyl fatty acids.

In an embodiment, the culturing comprises addition of a second carbon source. In an embodiment, the second carbon source comprises an agro-wastewater. In an embodiment, the second carbon source comprises an industrial wastewater. In an embodiment, the second carbon source comprises an agro-industrial wastewater.

In an embodiment, the method further comprises a step of recovering the PHA from the bacterial strain. In an embodiment, the bacterial strain is a Zobellella denitrificans ZD1 strain. In an embodiment, the bacterial strain is a Pseudomonas oleovorans strain.

In an embodiment, the PHA is PHB. In an embodiment, the PHA comprises repeating units of a SCL hydroxyl fatty acid, a MCL hydroxyl fatty acid, or a combination thereof. In an embodiment, the PHA comprises SCL hydroxyl fatty acids. In an embodiment, the PHA comprises MCL hydroxyl fatty acids.

In an embodiment, the step of recovering comprises addition of a natural coagulant to the culture of the bacterial strain. In an embodiment, the natural coagulant is chitosan. In an embodiment, the natural coagulant is added to media of the culture. wherein the step of recovering comprises recovering a bacterial biomass.

In an illustrative aspect, a food composition comprising a biomass is provided, wherein the biomass is an immune-stimulating biomass. In an embodiment, the food composition is an aquaculture food composition. In an embodiment, the food composition is a fish food composition. In an embodiment, the biomass is harvested using chitosan.

In an embodiment, the biomass comprises polyhydroxyalkanoate (PHA). In an embodiment, the PHA is poly(3-hydroxybutyrate) (PHB). In an embodiment, the PHA comprises repeating units of a SCL hydroxyl fatty acid, a MCL hydroxyl fatty acid, or a combination thereof. In an embodiment, the PHA comprises SCL hydroxyl fatty acids. In an embodiment, the PHA comprises MCL hydroxyl fatty acids.

In an embodiment, the biomass is produced via Zobellella denitrificans (ZD1) strain. In an embodiment, the biomass is produced via Pseudomonas oleovorans strain. In an embodiment, the biomass comprises one or more single cell proteins.

In an embodiment, the food composition is combined with fishmeal. In an embodiment, the food composition is combined with fish oil. In an embodiment, the food composition comprises anti-microbial functionality. In an embodiment, the food composition is substantially free of antibiotics.

In an illustrative aspect, a method of feeding an animal is provided comprising the step of providing a food composition to the animal. The food composition utilized in the method can be any of the food compositions described herein. In an embodiment, the animal is an aquatic animal. In an embodiment, the animal is a fish. In an embodiment, the animal is a mammal. In an embodiment, the animal is a livestock animal.

In an illustrative aspect, a method of stimulating an immune response in an animal is provided comprising the step of providing a food composition to the animal to stimulate the immune response in the animal. The food composition utilized in the method can be any of the food compositions described herein.

In an embodiment, the immune response protects the animal against one or more aquaculture pathogens. In an embodiment, the aquaculture pathogen is Vibrio campbellii. In an embodiment, the aquaculture pathogen is Aeromonas hydrophila. In an embodiment, the aquaculture pathogen is Streptococcus agalactiae.

In an embodiment, the immune response protects the animal against one or more aquaculture non-pathogens. In an embodiment, the aquaculture non-pathogen is Escherichia coli. In an embodiment, the aquaculture non-pathogen is Bacillus megaterium. In an embodiment, the aquaculture non-pathogen is Rhodococcus jostii RHA1.

In an embodiment, the immune response protects the animal against a Gram positive bacterium. In an embodiment, the immune response protects the animal against a Gram negative bacterium. In an embodiment, the immune response protects the animal against a warm water pathogen. In an embodiment, the immune response protects the animal against a cold water pathogen.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

### Example 1

### Exemplary Experimental Procedures

The instant example provides exemplary materials and methods utilized in Examples 2-6 as described herein.

Chemicals, Strain, and AW Collection. Natural clinoptilolite-type zeolites, with a particle size of 4-7 mm, were procured from Marineland, Blacksburg, Va. Chitosan with low and medium molecular weight (M_{w}) (75%-85% deacetylation degree) and FeCl₃ as a traditional coagulant) were purchased from Sigma-Aldrich, USA. Glycerol (≥99%) and commercial PHB were obtained from Sigma-Aldrich, USA. Strain Z. denitrificans ZD1 (JCM 13380) was obtained from Riken BRC Microbe Division, Japan.

AW was collected from the Texas A&M Aquacultural Research and Teaching Facility in College Station, Tex. The AW contained 3-g/L NaCl and was centrifuged to separate the liquid and solids. The supernatant and solid fraction were stored at 4° C. before use.

Nitrogen Adsorption and Desorption Experiments. The natural zeolite was rinsed with DI water and oven-dried at 105° C. for 6 hours before use Ammonium was used as the model N form in the adsorption/desorption experiments as it is the major N content in AW (constitutes ˜90%, range=0.12-345 mg NH₄⁺—N/L), depending on the type of aquatic species and the culture system. For the adsorption experiments, a series of flasks was prepared by adding 1.25 g zeolite to 25 mL DI water containing ammonium-nitrogen concentrations ranging from 10-500 mg NH₄⁺—N/L. The flasks were incubated at room temperature while shaking at 150 rpm for 24 h. Liquid samples were collected at different regular intervals and analyzed for NH₄⁺—N concentration. Data collected from the 24-h samples were used to estimate the ammonium adsorption capacity of zeolite (q in mg NH₄⁺—N/g) using Eq. (1):

$$q = ( {C}_{0} - {C}_{f} ) \times ( \frac{V}{m} ) \qquad ( 1 )$$

where C₀ and C_{f} are concentrations of NH₄⁺—N before and after adsorption, respectively. V represents the liquid sample volume (L), and m represents the zeolite mass (g).

The desorption experiments were conducted in a series of flasks as described below. Briefly, spent zeolites were produced by incubating zeolites with 500 mg NH₄⁺—N/L for 4 hours similar to those described in the adsorption experiments. Then, a known amount of spent zeolites (50 g/L of N-laden zeolite) was added to a flask containing 25 mL of one of the following extraction solutions: 1 M HCl, 1 M NaOH, 3-10% NaCl, or DI water. The flasks were then incubated at 25° C. for 24 hours before collection for NH₄⁺—N analysis. The N desorption efficiency (%) was determined by dividing the total mass of NH₄⁺—N in the solution over the total mass of NH₄⁺—N retained in the spent zeolites. For the set that was extracted with 3% NaCl, the desorption process was repeated two more cycles to assess the maximum amount of ammonium that can be desorbed.

Another set of adsorption-desorption experiments using the supernatant fraction of AW was conducted similarly. All the experiments were conducted in duplicate.

Z. denitrificans ZD1 Cultivation Experiments. Two sets of Z. denitrificans ZD1 cultivation experiments were conducted using (i) N released in the 3% NaCl extraction solutions obtained from the spent zeolites as described above in N adsorption-desorption experiments, and (ii) different non-sterile agro-industrial wastes/wastewater. All the growth experiments were conducted in 250-mL flasks, and Luria-Bertani medium (LB)-grown Z. denitrificans ZD1 was used as an inoculum (4% v/v), which was prepared by growing Z. denitrificans ZD1 in LB medium at 30° C. and shaking at 150 rpm for 24 h. After incubation, the culture was pelleted at 4,500×g for 10 minutes at 4° C., and the pellet was re-suspended in N-free mineral salt medium (MSM) to an optical density (OD₆₀₀) of 0.9-1.0. Experimental details are described below.

(i) Z. denitrificans ZD1 Cultivation using N released from the Spent Zeolites. As described in the desorption experiments, the spent zeolites were subjected to three cycles of desorption using 3% NaCl extraction solution, resulting in three extracts containing different levels of NH₄⁺—N (hereinafter designated extract-1, extract-2, and extract-3). The 3% NaCl in these solutions provided an ideal condition for the non-sterile cultivation of PHB-rich Z. denitrificans ZD1, and thus there will be no need for sterilization.

The growth experiments were conducted in a series of 250-mL flasks containing 5 g/L glycerol, one of the three extracts, and LB-grown Z. denitrificans ZD1 (4% v/v) in 50 mL of N-free MSM. The N-free MSM medium was modified from the MSM by removing the ammonium component. The flasks were incubated at 30° C. and 150 rpm, and samples were intermittently collected to monitor the growth of Z. denitrificans ZD1. Another parallel set of growth experiment was conducted similarly, except that the 3% NaCl extraction solution derived from the supernatant of AW adsorption-desorption experiments (hereinafter extract-AW) was used. Z. denitrificans ZD1 cultivation in the supernatant of AW before and after adsorption were used as positive and negative controls, respectively.

(ii) Z. denitrificans ZD1 Cultivation using Different Non-sterile Agro-industrial Wastes/Wastewater. Non-sterile agro-industrial wastes/wastewaters (glycerol, CWW, and aquaculture solid waste) were used as additional C-sources to increase the biomass production of PHB-rich Z. denitrificans ZD1. Glycerol (10 g/L) was prepared in MSM as reported previously. CWW, containing the last remnant from ricotta cheese production, was prepared as described previously, with some modifications. Briefly, 4 L of whole milk was heated up to 82° C. before acidification with citric acid (7% v/v), followed by gentle mixing to form cheese. After the curd was firmed, CWW was flocculated by adding 750 mg/L medium M_{w} chitosan (dissolved in 1% v/v acetic acid). The mixture was settled at room temperature, and a clear supernatant (or so-called CWW) was collected for experimental use. Aquaculture solid waste previously prepared by centrifugation of AW was used and pretreated with three solubilization methods: (i) using one cycle of heat and pressure by sterilization at 120° C., (ii) increasing the pH to 10 by adding 2 M NaOH, or (iii) adding different amounts of peracetic acid (1-5% v/v). Then, the samples were incubated for 24 hours and centrifuged (10,000×g, 4° C.), and then the supernatant was collected and neutralized with 2 M HCl to bring the pH to 7.5. The physicochemical properties (such as COD, total nitrogen (TN), salinity, and pH) of these agro-industrial wastes/wastewaters are listed herein.

Similarly, the growth experiments were conducted in 250-mL flasks containing LB-grown Z. denitrificans ZD1 (4% v/v) in 50 mL of one of the wastewater/wastes (glycerol, CWW, and aquaculture solid wastes). Liquid samples were collected at the stationary growth phase to determine cell dry weight (CDW), PHB content, TN, COD, and biomass composition. Removal efficiencies of COD and TN of the tested wastes/wastewaters were also determined. The entire experimental process did not involve sterilization.

Z. denitrificans ZD1 Biomass Harvesting Experiments. Batch experiments were performed to investigate the efficacy of two coagulants, FeCl₃ and chitosan, on harvesting the stationary culture of Z. denitrificans ZD1 (OD₆₀₀˜2.0) grown on glycerol in the supernatant of AW. Briefly, the cell suspension (20 mL) was supplied with 5-500 mg/L chitosan or 10-500 mg/L FeCl₃ under different pH (5, 7, and 9) conditions. The mixtures were then placed on a rotary shaker at 150 rpm for 2 minutes, followed by a slow mixing at 40 rpm for 15 minutes, before settling for 20 minutes without disturbance. The supernatant was then collected for OD₆₀₀ measurement. The effects of high salinity (3% NaCl) on cell harvesting were also examined using the optimum coagulation condition determined above. All the harvesting experiments were conducted in triplicate. The harvesting efficiency was determined using Eq. (2):

$$Harvesting Efficiency ( \% ) = ( 1 - \frac{{OD}_{sample}}{{OD}_{control}} ) \times 100 \qquad ( 2 )$$

where ODₛₐₘₚₗₑ and OD_{control} refers to the optical densities of the supernatant of samples and controls, respectively. The controls refer to those with Z. denitrificans ZD1 cell suspension only. The samples refer to the supernatant of treatments (i.e., Z. denitrificans ZD1 cell suspensions received different dosages of coagulant).

Analytical Methods. Physicochemical parameters such as cell growth, absorbance, CDW, COD, NH₄⁺—N, and TN-N were determined according to standard methods and can be found in the Supporting Information. The PHB content in CDW (glycerol- and CWW-grown Z. denitrificans ZD1 biomasses) was spectrophotometrically determined via conversion of PHB to crotonic acid. The biomass composition (i.e., crude protein, lipid, and ash contents) was determined as described previously.

Economic Analysis. An economic analysis was conducted on farm fish by using commercial fish feed and antibiotic in conventional RAS as a benchmark against the scenario of farming fish with PHB-rich Z. denitrificans ZD1 and reusing the treated AW in the proposed RAS-PHB. The key elements of the analysis include the fish species (tilapia and red drum), annual production rate (500 ton/year), RAS volume (1000 m³), and expected stock density (50 kg fish/m³).

### Example 2

### Effectiveness of Natural Zeolite for Ammonium Recovery

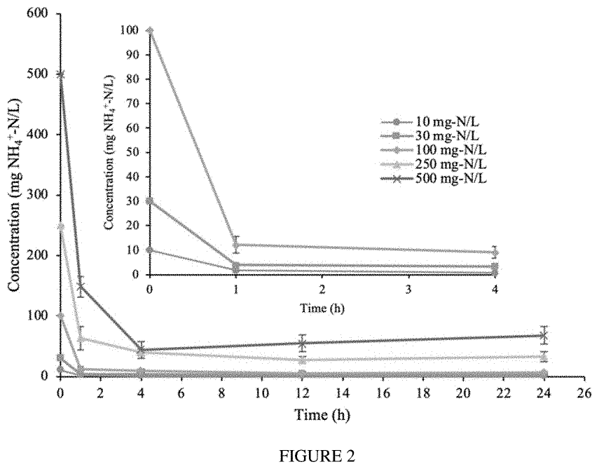

As shown in FIG. 2, zeolites were able to adsorb a wide range of NH₄⁺—N concentrations (10 to 500 mg NH₄⁺—N/L) in DI water within the first 4 hours and reached greater than 88% of ammonium removal efficiency. By using the last data points of the tests, the adsorption capacity was estimated to be 7.4 mg NH₄⁺—N/g zeolite, which falls in a range previously reported for clinoptilolite-type zeolites (6-9 mg NH₄⁺—N/g).

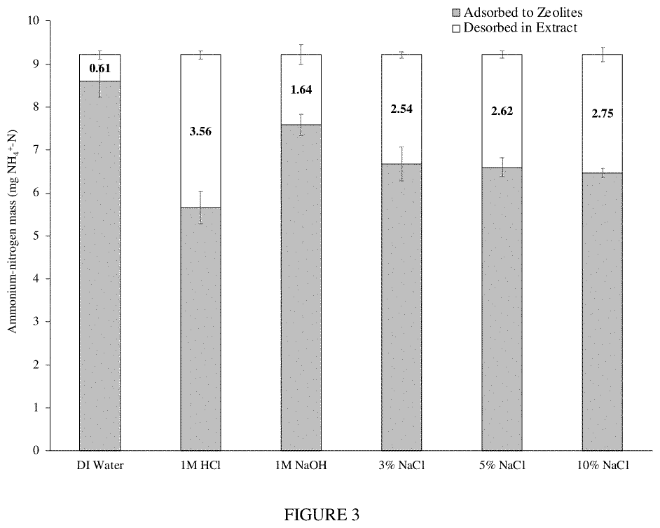

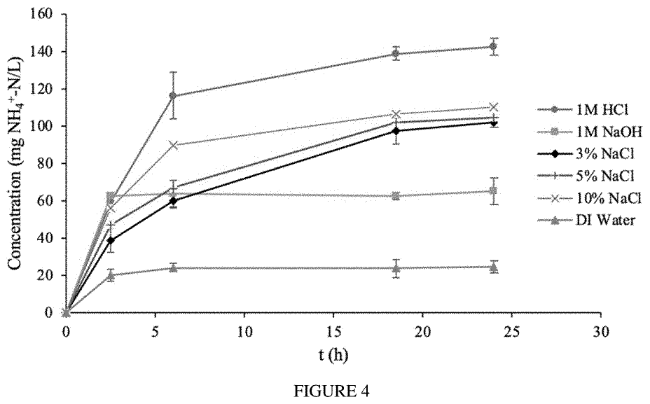

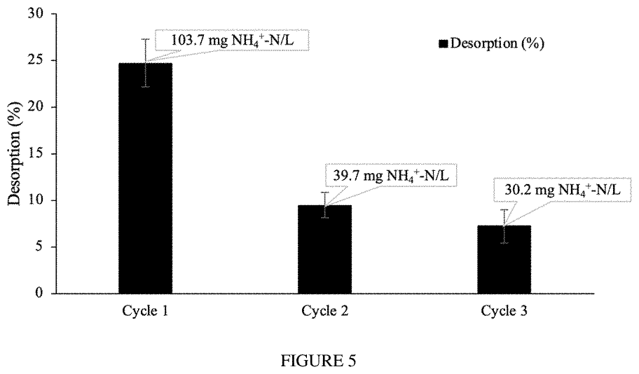

After 24 hours of incubation, ammonium was desorbed from the NH₄⁺-laden zeolites into the tested extraction solutions with different desorbing efficiencies and quantities (shown in parenthesis) from low to high: DI (13%; 0.61 mg NH₄⁺—N)<1 M NaOH (17%; 1.64 mg NH₄⁺—N)<3% NaCl (28%; 2.54 mg NH₄⁺—N)=5% NaCl (28%)<10% NaCl (30%; 2.75 mg NH₄⁺—N)<1 M HCl (39%, 3.56 mg NH₄⁺—N) (FIG. 3 and FIG. 4). Additional two desorption cycles with 3% NaCl (FIG. 5) released a total of 3.9 mg NH₄⁺—N from the zeolites, which corresponded to 42% of the amount sorbed into the zeolites.

The different ammonium desorption efficiencies in the extraction solutions could be attributed by the ammonium adsorption mechanisms in zeolites. NH₄⁺ removal by zeolites could be attributed to the high ion-exchange with Ca²⁺, Na⁺, K⁺, and Mg²⁺ in zeolites. Moreover, based on the pKₐ of ammonium (9.25), the pH of the extraction solution could impact the predominant ammoniacal species attached to zeolites (i.e., NH₄⁺ in acidic medium and NH₃ in alkaline medium), resulting in the highest and lowest levels of desorption in the HCl and NaOH extraction solutions, respectively (FIG. 3). In saline solution, the Na competes with NH₄⁺ for the adsorption sites in zeolites. As salinity increased, more NH₄⁺ on the zeolites were displaced and released into the extraction solution. The desorption results observed with using DI water only, showed there was no Na for ion exchange. Furthermore, the incomplete ammonium recovery (i.e., 42% of adsorption capacity) after three cycles of 3% NaCl desorption could be attributed to the hydrated ionic radius (i.e., Na⁺ radius>NH₄⁺), which may block Na⁺ from percolating and reaching the adsorption sites. Overall, our adsorption results at various initial ammonium concentrations represent scenarios in which zeolite has been applied for treating several ammonium-strength wastewaters, such as dairy processing wastewaters, landfill leachate, and sewage sludge leachate. Based on the desorption results, a high salinity solution (3-5% NaCl) can be used for regenerating NH₄⁺-laden zeolites. Without being bound by any theory, using the acidic extraction method could render an unsuitable medium for the subsequent Z. denitrificans ZD1 cultivation. The total amount of released NH₄⁺—N was considered sufficient to secure microbial biomass production needs.

### Example 3

### Feasibility of Using N in the Extracts of Spent Zeolites for Z. denitrificans ZD1 Cultivation

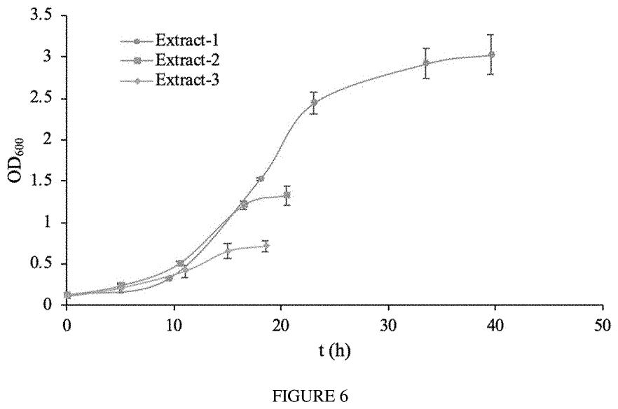

Z. denitrificans ZD1 Cultivation by using the Ammonium in the Extracts of Spent Zeolites. Z. denitrificans ZD1 was able to grow on glycerol and N in the three saline extracts (3% NaCl) of the spent zeolites in N-free MSM (FIG. 6). The growth of Z. denitrificans ZD1 was the highest in extract-1 (OD₆₀₀=3.5), followed by those in extract-2 (OD₆₀₀=1.2) and extract-3 (OD₆₀₀=0.7). The observed cell concentrations were directly proportional to the amounts of released NH₄⁺—N in the extracts (FIG. 5), demonstrating that it is feasible to cultivate Z. denitrificans ZD1 with the desorbed ammonium from the spent zeolites.

Z. denitrificans ZD1 Cultivation using N Recovered from AW. After 4 hours of adsorption, zeolites were able to remove 100% TN-N from real AW with a TN concentration of 25 mg TN-N/L (Table 1). This zeolite's ammonium adsorption performance for AW was similar to those for 30 mg NH₄⁺—N/L in DI water (FIG. 4).

TABLE 1
Characteristics of agro-industrial wastewaters used for the
non-sterile production of PHB-rich Z. denitrificans ZD1 biomass

| Organic Waste | COD (g/L) | TN (g-N/L) | Salinity (g/L) | pH |
|---|---|---|---|---|
| AW | 0.205 | 0.025 | 3 | 8.2 |
| Glycerol | 12.2 | — | 30 | 7.4 |
| CWW | 50.4 | 1.47 | 0 | 6.5 |

Note:
AW = Aquaculture wastewater (i.e., fish tank effluent)
CWW = Cheese production wastewater

However, after 24 hours of incubating the N-laden zeolites with 3% NaCl extraction solution, only 28% of the adsorbed TN (i.e., 8 mg TN-N/L in the extract-AW) was released. The desorption efficiency of the spent zeolites used for adsorbing ammonium in AW was much lower when compared with those used for adsorbing ammonium in DI water. Without being bound by any theory, the presence of organics (proteins and organic acids) in AW (COD=205 mg/L in Table 1) may have also been attached to zeolites during the adsorption process. Without being bound by any theory, the adsorbed organics on the zeolites might compete with the adsorbed ammonium for Na⁺ in the NaCl extraction solution, limiting the release of adsorbed ammonium.

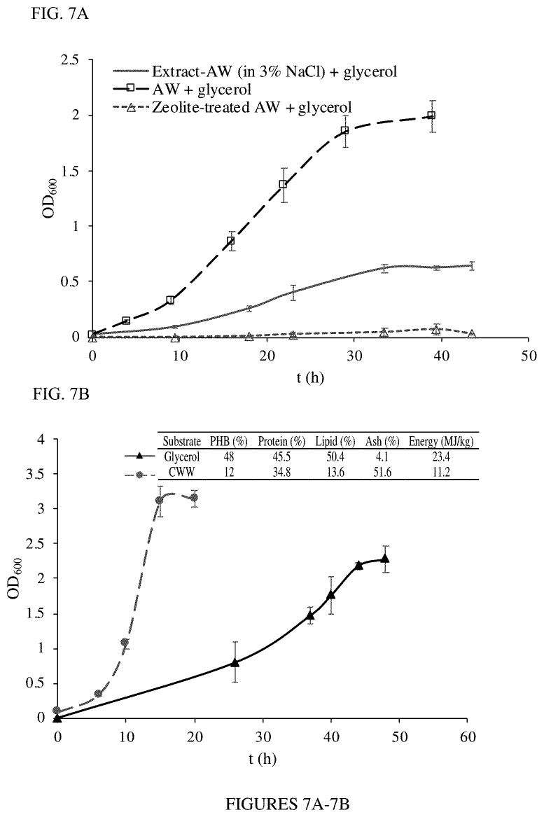

The extract-AW from the desorption process was used for Z. denitrificans ZD1 cultivation. As shown in FIG. 7A, Z. denitrificans ZD1 was able to grow with glycerol as an additional C-source and the extract-AW in N-free MSM. The growth of Z. denitrificans ZD1 reached an OD₆₀₀ of 0.65, while no growth was observed in samples supplied with glycerol and zeolite-treated AW. However, using AW supernatant (without using zeolites for N removal) and glycerol, Z. denitrificans ZD1 was able to grow to a high OD₆₀₀ of 2. Without being bound by any theory, the low OD observed in the samples with extract-AW could be attributed to the low N supply (8 mg TN-N/L). Overall, these results demonstrated that it could be feasible to treat and recover N from AW for Z. denitrificans ZD1 cultivation.

### Example 4

### Non-Sterile Cultivation of PHB-Rich Z. denitrificans ZD1 Using Agro-Industrial Wastes/Wastewaters

Cultivation of Z. denitrificans ZD1 using Aquaculture Solid Waste, Glycerol, and CWW. Z. denitrificans ZD1 was unable to use aquaculture solid waste as a C-source. Solid waste mainly consists of fish feces and organics, and they are mostly in particulate form. As grain and plant materials are common ingredients in fish feed, undigested fibers contribute to a large fraction of non-biodegradable complex organics in the fish feces. Without being bound by any theory, Z. denitrificans ZD1 could be unable to use the complex organics for growth.

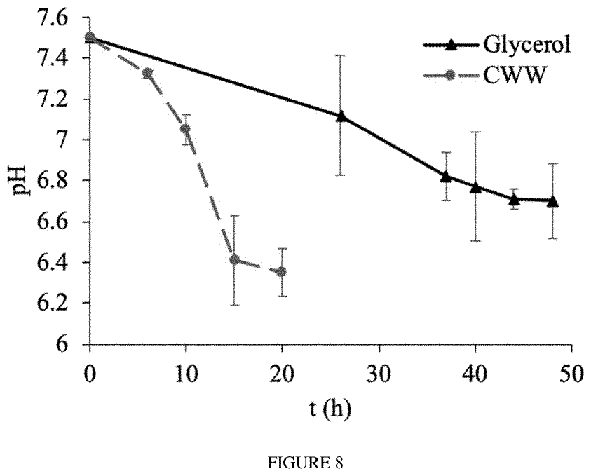

Unlike aquaculture solid wastes, Z. denitrificans ZD1 was able to grow in glycerol and CWW as supplementary C-sources (FIG. 7B). The CWW-supplied Z. denitrificans ZD1 grew faster and reached a higher OD (OD₆₀₀=3.3) in 20 hours compared with glycerol-supplied Z denitrificans ZD1 (OD₆₀₀=2.3 in 44 h). The maximum CDW of CWW-grown Z. denitrificans ZD1 was 3.24 g/L, which was 1.65-fold higher than that of glycerol-grown Z. denitrificans ZD1 (Table 1). Surprisingly, a high COD removal (80%) was observed in glycerol-amended samples, whereas a low COD removal (33%) was observed in CWW-supplied samples. Without being bound by any theory, the differences in COD removals could be attributed to the rapid decrease in pH in the growth medium (FIG. 8), which was associated with the growth of Z. denitrificans ZD1. The pH profile depressed with Z. denitrificans ZD1 growth until the stationary phase, reaching the lowest pH value of 6.35 for CWW at the end of cultivation. Without being bound by any theory, this low pH compared with glycerol could have hindered Z. denitrificans ZD1 to further grow and utilize CWW. Additionally, the initial COD in CCW was 50 g/L compared with 12.2 g/L in glycerol (Table 1), which could explain the final measured COD. These results suggest that Z. denitrificans ZD1 can utilize glycerol and CWW for growth while treating these wastes.

SCP Characterization. The inset table in FIG. 7B describes the key elements in the SCP biomass of glycerol- and CWW-grown Z. denitrificans ZD1. Despite the lower CDW achieved by glycerol-grown Z. denitrificans ZD1, their biomass contained a higher PHB content (48% in CDW) than that of CWW-grown Z. denitrificans ZD1 biomass (12%). By taking the total biomass of glycerol- and CWW-grown Z. denitrificans ZD1 into consideration, the total mass of PHB from glycerol (47.5 mg) was significantly higher than that from CWW (20 g).

The accumulation of PHB by Z. denitrificans ZD1 is growth-associated, i.e., it is stored during growth and unaffected by the limitation of nutrients. When Z. denitrificans ZD1 is cultivated in crude glycerol, high-strength wastewater, and activated sludge, comparable PHB production (0.38-3.44 g/L) can be yielded. Therefore, the PHB production in this study further confirmed the importance of using Z. denitrificans ZD1 as it can attribute to the production of PHB from organic wastes in a continuous single-stage bioprocess without the need to operate under nutrient-limitation conditions. Nevertheless, the high PHB observation in glycerol compared with CWW can be attributed to the lower N supply in the media, which intensifies PHB accumulation. CWW contained higher COD and initial TN than glycerol (Table 1). Without being bound by any theory, this could explain the faster growth rate and higher biomass production in CWW. Lower N supply in glycerol may have had influenced Z. denitrificans ZD1 to prioritize PHB synthesis over biomass production. Overall, the results demonstrated that both CWW and glycerol as C-sources successfully produced PHB-rich biomass. Thus, both waste options could be considered in future RAS processes upon their availability.

Compared with CWW-grown Z. denitrificans ZD1, glycerol-grown Z. denitrificans ZD1 contains more than 10% higher protein content, representing a higher protein quality by 45.5%. The lipid content of glycerol-grown Z. denitrificans ZD1 biomass was 50.4% (3.7 times more than in CWW). The energy content of glycerol-grown cells (23.4 MJ/kg) was greater than that of strains in CWW (11.2 MJ/kg). Finally, the CWW-grown Z. denitrificans ZD1 assimilated remarkably higher mineral content by 51.6%, whereas Z. denitrificans ZD1 on glycerol only assimilated 4.1%.

The nutritional analysis highlighted an imperative strategy that could be implemented for our proposed RAS-PHB; that is, different C-sources could be used based on the aquatic species being cultured (i.e., carnivorous and omnivorous) since each requires various fish feed quality. For example, to increase the protein content, glycerol may be considered as a C-source. Similarly, to obtain SCP with high mineral content to overcome mineral deficiency in fish feed, cultivation of Z. denitrificans ZD1 with CWW could be an optimal option. Other agro-industrial wastewaters (poultry, red meat, dairy, and sugar) could also be employed in our proposed RAS-PHB as these wastewater/wastes could yield different biomass quality. Most importantly, the high protein content in the glycerol-grown Z. denitrificans ZD1 meets the theoretical demand of protein in the fish feed for omnivorous or carnivorous fish, where their dietary protein demand is 40-55%. Z. denitrificans ZD1 biomass could be utilized as a replacement of feed for omnivorous fish species, such as tilapia, channel catfish, and common carp. It could even supplement some types of carnivorous fish such as red drum Sciaenops ocellatus, which needs lower protein content (40%). Nonetheless, in vivo fish trials should be conducted to determine the fish species and optimum inclusion levels of the prescribed diet. From nutrimental viewpoints, glycerol-grown Z. denitrificans ZD1 could be considered a more favorable SCP source than other microbial protein sources (microalgae and yeast) (Table 2). Notably, the energy content of glycerol-grown biomass (23.4 MJ/kg) is higher than that of commercially available fishmeal and soybean (20.1-21.3 MJ/kg) or in meat and bone meals (9.4-13.9 MJ/kg).

TABLE 2
Comparison of Biomass Composition in this Study with other Protein Sources.

| | | Energy | | | | | |
|---|---|---|---|---|---|---|---|
| | | Source/ | PHB | Protein^{a} | Lipid | Ash | Energy |
| Protein Source | | Substrate | (%) | (%) | (%) | (%) | (MJ/kg) |
| Microbial | Z. | Glycerol | 48 | 45.5 | 50.4 | 4.1 | 23.4 |
| biomass | denitrificans | CWW | 12 | 34.8 | 13.6 | 51.6 | 11.2 |
| (SCPs) | ZD1 | | | | | | |
| | Bacillus | Potato | | 38 | | 11 | |
| | licheniformis | processing | | | | | |
| | | waste | | | | | |
| | Purple | Light/Poultry | | ~75^{c} | ~20 | | 22 |
| | phototrophic | WW^{b} | | | | | |
| | bacteria | Light/Dairy | | ~61 | ~29 | | |
| | | WW | | | | | |
| | | Light/Sugar | | ~42 | ~20 | | |
| | | WW | | | | | |
| | Methane- | Biogas | 43-73 | 60 | 8-11 | 6-9 | |
| | oxidizing | methane | | | | | |
| | bacteria | | | | | | |
| | Hydrogen- | Hydrogen | 57 | 75 | — | | |
| | oxidizing | | | | | | |
| | bacteria | | | | | | |
| | Microalgae: | Light/ | | ~65 | ~27 | | |
| | Chlorella | Poultry | | | | | |
| | vulgaris and | WW | | | | | |
| | Scenedesmus | Light/ | | ~37 | ~59 | | |
| | species | Dairy | | | | | |
| | | WW | | | | | |
| | | Light/ | | ~14 | ~15 | | |
| | | Sugar | | | | | |
| | | WW | | | | | |
| | Yeast | Organic | | 45-55 | 1-6 | 5-10 | 19.9 |
| | | carbon | | | | | |

| | | | | |
|---|---|---|---|---|
| Fishmeal | 63 | 11 | 16 | 20.1 |
| Soybean meal | 44 | 2.2 | 5 | 21.3 |

### Example 5

### Harvesting Z. denitrificans ZD1 Using Coagulants

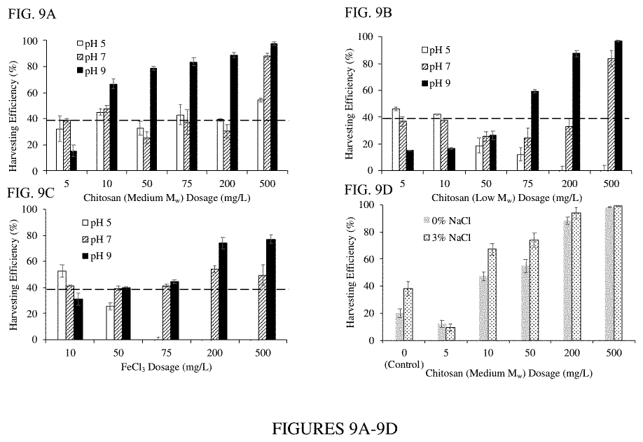

Effects of pH and Coagulant Dosage on Cell Harvesting. Medium M_{w} chitosan showed the highest harvesting efficiencies with broad ranges of pH and coagulant dosage (FIG. 9A). Under the ideal pH range between 7 and 9, a maximum harvesting efficiency of 97% for both medium and low M_{w} chitosan were obtained (FIGS. 9A and B) compared with those using FeCl₃ (77%) (FIG. 9C) and those of gravitational settling (i.e., controls) (39%). At pH 7 (i.e., also a typical pH value of AW), the harvesting efficiency of both types of chitosan (87%) (FIGS. 9A and B) was still higher than that of FeCl₃ (52%) (FIG. 9C), indicating that there could be an advantage of chitosan application without any pH adjustment. To enhance Z. denitrificans ZD1 biomass recovery, the performance of all coagulants was also examined in terms of their applied dosages. FIGS. 9A-C show that harvesting efficiency increased as coagulant dosage increased, except for FeCl₃ and low M_{w} chitosan at pH 5. Noted that FeCl₃ could not reach 80% efficiency at all dosages or pH values (FIG. 9C). In contrast, only 10 mg/L of the medium M_{w} chitosan was required to achieve 70% harvesting efficiency, which was 20 times lower than that of the FeCl₃ dosage (FIG. 9C).

The harvesting efficiency of medium M_{w} chitosan significantly surpassed that of FeCl₃ due to charge neutralization and/or bridging, whereby the suspended particles aggregated over a broader pH range. Under low pH conditions, FeCl₃ lacks charge neutralization because of lower amounts of positively charged species such as FeOH²⁺ and Fe(OH)₂⁺, decreasing coagulation with the negatively charged cells. The higher the M_{w} of chitosan, the higher is the polymerization and cationic charge density. Therefore, medium M_{w} chitosan showed an expected higher efficiency than low M_{w} chitosan. These findings can substantiate the supremacy of bridging over charge neutralization in higher M_{w} chitosan. To conclude, based on harvesting efficiency and food safety concerns, organic chitosan coagulant could be utilized over the conventional inorganic FeCl₃ to harvest Z. denitrificans ZD1 biomass for fish feed.

Effects of Salinity. As the non-sterile production of Z. denitrificans ZD1 is possible under saline conditions (i.e., high salinity to prevent sterilization), the effects of salt levels on harvesting efficiency were investigated using medium M_{w} chitosan. As shown in FIG. 9D, regardless of dosages, salinity improved the coagulation performance. At low chitosan dosages of 10-50 mg/L, high salinity (3%) enhanced the harvesting efficiency by a 1.4-fold increase compared with the medium without salts. However, the addition of low chitosan dosages of 5 mg/L caused more turbidity in the medium, leading to a lower harvesting efficiency (10%). Without being bound by any theory, this could be attributed to the cationic charge density, which was not enough to destabilize the cells and reach the coagulation/flocculation threshold; thus, Z denitrificans ZD1 cells remained suspended. Furthermore, the salt effects decreased at a high chitosan dosage (200-500 mg/L), and a maximum efficiency of 98% was observed at 500 mg/L of chitosan despite of salinity. Moreover, without adding chitosan (control), 3% NaCl showed 39% harvesting efficiency (FIG. 9D).

The efficient harvesting performance of low dosages of medium M_{w} chitosan under higher NaCl can be attributed to the higher medium's ionic strength. The Z. denitrificans ZD1 cells, as other bacteria, were stabilized in the suspension due to the electrostatic repulsion within the long double layers. Therefore, as ionic strength increases, the double layer becomes compressed, bringing cells closer via van der Waals forces. Therefore, the high NaCl content acted as an aid, thus increasing the harvesting efficiency and lowering the required chitosan dosage. In contrast, insignificant difference in efficiencies at high chitosan dosages could be attributed to the bulky chemical structure of chitosan, which contains an acetyl group exhibiting a high degree of hydrophobicity. Overall, lower chitosan dosages could be applied under high salinity to achieve cost-effective biomass recovery. The optimal Z. denitrificans ZD1 biomass recovery (80%) could be obtained using medium M_{w} chitosan (50 mg/L) at pH<9 and 3% NaCl.

### Example 6

### Economic Assessment, Significance, and Limitations of the Proposed RAS-PHB

Three main processes were considered in the feasibility of using the proposed RAS-PHB for sustainable aquaculture. These processes are (i) implementation of zeolite-based adsorption and desorption mechanisms to recover and reuse ammonium from AW, (ii) supplementing agro-industrial wastes/wastewater along with ammonium recovered from AW to produce large quantities of PHB-rich SCP in saline medium without sterilization, and (iii) application of chitosan to effectively harvest PHB-rich Z. denitrificans ZD1 for fish feed.

Economic Assessment. A comparative economic analysis of RAS-PHB with RAS is summarized in Table 3, where only the monetary costs influencing the final price were considered. Farming with a conventional RAS, the total annual tilapia (omnivorous fish species) production costs were estimated to be 1.2$/kg for using antibiotic supplement (Scenario TA) and 1.6$/kg for using pure commercial PHB as a feed supplement (Scenario TB) (Table 3). While farming with the proposed RAS-PHB, total production costs were 0.7 or 0.6$/kg for glycerol-grown PHB-rich Z. denitrificans ZD1 (Scenario TC) or CWW-grown Z. denitrificans ZD1 (Scenario TD), respectively, when PHB-rich Z. denitrificans ZD1 was used as an alternative to biocontrol agents and as a protein and energy source in fish feed. Without being bound by any theory, both Scenarios TC and TD suggest that the employment of the proposed RAS-PHB could result in a 41-56% profit margin. The feed cost was lowered 2.5-fold in RAS-PHB by replacing 60% of the regular feed with PHB-rich biomass (Table 3). The glycerol-grown Z. denitrificans ZD1 containing high PHB content (48%) could be utilized as a replacement for commercial fish feed, as the PHB-rich Z. denitrificans ZD1 biomass can not only eliminate the use of antibiotics but also reduce the high cost of pure commercial PHB. In fact, by using the glycerol-grown Z denitrificans ZD1, the amount of PHB to be supplemented in the feed will be 0.37 kg/kg, which is about 3× higher than what is required to promote the growth and survival of Nile tilapia against Edwardsiella ictaluri.

TABLE 3
Annual Costs of the Conventional and Proposed RAS-PHB
Based on Normalized Fish Production Capacity.

| | Normalized Production Costs (S/kg) | | | | | | | |
|---|---|---|---|---|---|---|---|---|
| | Conventional RAS | | | | Proposed RAS-PHB | | | |
| | Tilapia | | Red drum | | Tilapia | | Red drum | |
| | Scenario | Scenario | Scenario | Scenario | Scenario | Scenario | Scenario | Scenario |
| Item | TA | TB | RA | RB | TC | TD | RCD | RD |
| Regular fish feed | 0.9 | 0.9 | 0.8 | 0.8 | 0.36 | 0.36 | 0.32 | 0.32 |
| Water replacement | 0.024 | 0.024 | 0.024 | 0.024 | — | — | — | — |
| Solid waste disposal | 0.15 | 0.15 | 0.2 | 0.2 | — | — | — | — |
| Antibiotics | 0.08 | NS^{a} | 0.08 | NS | NS | NS | NS | NS |
| Pure commercial PHB | NS | 0.48 | NS | 0.48 | NS | NS | NS | NS |
| PHB-rich ZD1 | NS | NS | NS | NS | 0.17 | 0.08 | 0.21 | 0.09 |
| Chitosan coagulant | — | — | — | — | 0.19 | 0.14 | 0.24 | 0.21 |
| Total ($/kg) | 1.2 | 1.6 | 1.1 | 1.5 | 0.7 | 0.6 | 0.8 | 0.6 |

Note:
RAS was assumedly used to culture tilapia (T) or red drum (R) with a production of 500 ton/year, a volume of 1000 m², and a stock density of 50 kg fish/m². Scenarios TA and TB and Scenarios RA and RB represent the conventional RAS with the supplementation of antibiotics or pure commercial PHB, respectively, to achieve the same overall tilapia (T) and red drum (R) prodcution. Scenarios TC and TD and Scenarios RC and RD represent the proposed RAS-PHB with the supplementation of glycerol- or CWW-grown PHB-rich Z.denitrificans ZD1, respectively, as alternatives.
^{a}NS = Not Supplemented. See information for assumptions and calculation details of each items.

Significance. In the proposed RAS-PHB system, using zeolites to adsorb-desorb ammonium from AW for sustainable SCP production could be advantageous. This approach could address the first main challenge in aquaculture industry—treatment and management of ammonia-strength wastewater and solid waste. In addition, it could allow a better control of the N content in the cultivation of SCP to minimize potential growth inhibition, which may arise through the direct application of wastewaters as substrates because of the high suspended solids. Mostly, zeolite could exhibit a lower material cost than the conventional biological N removal technologies, such as biofilters in RAS.

In the second process, the different Z. denitrificans ZD1 performance in the agro-industrial wastes could indicate the high potential of this strain to adapt to varying nutrient dynamics to produce SCP as fish feed. This produced SCP could tackle another major aquaculture challenge represented in the reduction of expensive aquafeeds. Furthermore, the produced SCPs could address a significant sustainability metric that is the reduction in the ratio of wild fisheries inputs (i.e., forage fish: anchovies, menhaden, and sardines) to farmed fish outputs or the “fish-in to fish-out” ratio, which have been continuously endorsed by many scientists and professionals in the aquaculture industry. Besides the excellent accumulation of the healthy feed additive (PHB) as a replacement for antibiotics, which is a major aquaculture challenge, the produced PHB-rich SCP can have many advantages: higher biomass yield than methane or hydrogen-oxidizing bacteria and lower land/water requirement and anti-nutritional factors compared with soybean. It is also imperative to recognize that our proposed system could lift the energy-intensive illumination required for traditional SCPs (such as purple phototropic bacteria or algae). Such an advantage agrees with the “dark food chain”, wherein chemoheterotrophy substitutes photosynthesis of SCPs as animal feed or human food.

The digestibility of aquaculture feed is commonly assessed as apparent digestibility coefficients. In general, microbial biomass has shown high apparent digestibility. Some bacterial biomass has higher digestibility than algae or yeast because it has a more digestible cell wall. Algae and yeasts' cell walls are characterized to be rough (i.e., comprises 25-30% and 10% of the yeast and algal dry matter, respectively), and composed of complex heteropolysaccharides, mannoprotein, and glucan. Without being bound by any theory, it could be reasonable that Z denitrificans ZD1, as a fish feed, could be highly digestible. This issue, however, warrants in vivo fish tests to assess the digestibility of Z. denitrificans ZD1 and the potential outcomes of the accumulated PHB. In this regard, the application of PHB as an aquaculture feed supplement could be utilized to result in an improvement in growth, survival, and immune system. The findings suggest that PHB application could be species- or life stage-specific. Therefore, other microorganisms known for producing polyunsaturated fatty acids (PUFAs) such as microalgae and fungi could be employed in RAS-PHB and serve as a feed supplement. PUFAs, particularly eicosapentaenoic and docosahexaenoic acids, are known to be essential supplements in the aquaculture feed as they can improve fish health and the quality of seafood produced (e.g., increased omega-3 content in the seafood). In this context, the proposed RAS-PHB system is still an optimal technology as the system could be further expanded and generalized for cultivating other microbial biomasses such as PUFAs-producing microalgae under mixotrophic conditions (i.e., autotrophic and heterotrophic).

Finally, the use of chitosan in SCP harvesting could be considered remedial and safe for fish consumption, as it is obtained from crab and shrimp wastes. Some positive effects could be attributed to chitosan as a growth-promoting compound and as an antimicrobial and immunostimulant in aquatic animal feed. Without being bound by any theory, improved re-cultivation of microalgae could be attributed to SCPs in the chitosan spent medium compared with the (toxic) alum-harvested medium due to the adaptation of the unharvested cells to the environment and substrate. Thus, re-cultivation of Z. denitrificans ZD1 could be a technique in reducing associated SCP production costs.

Limitations. It is important to note that this study mainly intended to validate RAS-PHB as a proof-of-concept. The effects of environmental and operational changes due to the differences in farmed aquatic animals, carbon feedstocks, ammonia-nitrogen concentrations, and pH in the wastewater were not investigated. Nevertheless, the results of this study demonstrated that RAS-PHB could be feasible and economical; the proposed system operated efficiently with real aquaculture wastewater and successfully produced and harvested biomass under typical aquaculture conditions. Thus, future research is needed to examine the effects of those environmental and operational changes on the long-term RAS-PHB performance to provide the required knowledge for future development of a full-scale RAS-PHB system.

Fish feed ingredient has been recently suggested as a potential source of off-favors in aquaculture. Geosmin and 2-methylisoborneol (MIB) are the two most recognized off-flavor compounds in fish. Accordingly, to consider Z. denitrificans ZD1 as a viable fish feed, it is important to examine if Z. denitrificans ZD1 can produce and/or accumulate these off-flavor compounds. By examining the genome of Z. denitrificans ZD1, no genes encoding enzymes involved in the synthesis of geosmin (i.e., geoA, cyc2, spterp13, and tpc) and MIB (i.e., mtf, mic, sco7700, and sco7701) were identified. Without being bound by any theory, Z. denitrificans ZD1 could be unable to produce these compounds. Furthermore, zeolites have been shown to remove or decrease geosmin and MIB in water. Thus, off-flavors compounds in AW could be controlled by the natural zeolite filter unit of the PHB-RAS system.

Other salt-tolerant non-PHB-producing microorganisms could be present in 3% saline AW, resulting in co-cultivation of non-PHB-producing microorganisms and PHB-producing Z denitrificans ZD1. One measure to minimize and suppress the growth of these salt-tolerant non-PHB-producing microbes is to increase salinity (higher than 3%) in the medium, as Z denitrificans ZD1 was able to survive salt concentration as high as 5% (50 g/L), and up to 12% (120 g/L), the conditions that many microorganisms cannot tolerate. Alternatively, increasing Z denitrificans ZD1 inoculation population could be able to outcompete other salt-tolerant microorganisms during non-sterile cultivation.

### Example 7

### Exemplary Experimental Procedures

The instant example provides exemplary materials and methods utilized in Examples 8-11 as described herein.

Zobellella denitrificans ZD1 (JCM 13380), a PHB-accumulating strain, and three known aquaculture pathogens Vibrio campbellii (DSM 19270) (G− strain), Aeromonas hydrophila (G− strain), and Streptococcus agalactiae (G+ strain) were used. Non-pathogenic strains of Escherichia coli (ATCC 10798) (G− strain), Bacillus megaterium (ATCC 14581) (G+ strain), and Rhodococcus jostii RHA1 (G+ strain, designated as RHA1 hereafter) were used. The sources of bacterial strains are provided in the Supporting Information (SI).

Medium molecular weight (M_{w}) chitosan (190-310 kDa; 75-85% deacetylation degree), chitosan oligosaccharide lactate (COS) (M_{w}=4-6 kDa), 3-hydroxybutyrate (3-HB) (≥99.0% pure), butyrate (98% pure), crystalline PHB, and glycerol (≥99.5% pure) were purchased from Sigma-Aldrich, USA. High-quality hatching cysts of brine shrimp (Artemia franciscana, EG® Type) for the challenge tests were obtained from INVE Aquaculture, Great Salt Lake, Utah, USA.

Growth Inhibition Tests: Antimicrobial Properties of 3-HB, butyrate, COS, and 3-HB+COS. Growth inhibition tests were conducted in a series of 55-mL culture tubes containing 10-mL Luria-Bertani (LB) medium with one microbial strain type and one of these compounds (3-HB, butyrate, COS, or 3-HB+COS). The PHB intermediates (i.e., 3-HB and butyrate) and chitosan intermediate (COS) are water-soluble, representing the PHB and chitosan degradation products in the gastrointestinal tract of aquatic animals. These compounds were used to assess the antimicrobial efficacy of PHB and chitosan under the best scenario. Various concentrations of PHB intermediates (5-125 mM), COS (0.2-3 mM), or mixtures of 3-HB+COS (i.e., Mixture 1 (4 mM 3-HB+0.1 mM COS), Mixture 2 (12 mM 3-HB+0.3 mM COS), Mixture 3 (24 mM 3-HB+0.6 mM COS), and Mixture 4 (60 mM 3-HB+1.5 mM COS)) were used based on previously in vitro antimicrobial studies using PHB or chitosan. For S. agalactiae and RHA1, tryptic soy broth (TSB) and Reasoner's 2A (R2A) media were used, respectively. The pH of all growth mediums (i.e., LB, TSB, or R2A) was adjusted to 6.0 based on the typical pH value found in aquatic animals' gut and the optimized antimicrobial activity of PHB. The culture tubes were inoculated with 2% v/v of the pre-grown strains (optical density (OD₆₀₀) of 1.0) and incubated at 30° C. under 150 rpm. The bacterial growth was determined by absorbance at OD₆₀₀. The growth of tested strains in the absence of PHB or chitosan intermediates were used as controls. The inhibition efficiency (%) was calculated using Eq. (1):

$$Inhibition Efficiency ( \% ) = ( \frac{{OD}_{control} - {OD}_{sample}}{{OD}_{control}} ) \times 100 \qquad Eq . ( 1 )$$

where OD_{control} and ODₛₐₘₚₗₑ refer to the highest optical densities of the growth curves for the controls and samples, respectively. The minimum or median inhibitory concentrations (MIC and IC₅₀), representing the compound concentrations that inhibited 100% or 50% bacterial growth, respectively, were calculated.

Production and Preparation of P-ZD1 and CP-ZD1 Biomass. Glycerol was used to produce PHB-rich ZD1 biomass (P-ZD1) under nonsterile conditions and CP-ZD1 biomass was obtained by harvesting the P-ZD1 during the stationary growth phase with a chitosan biocoagulant agent as described in the RAS-PHB system.

Artemia Starvation and Pathogen Challenge Tests. Gnotobiotic Artemia nauplii were hatched and prepared as previously described with a minor modification. Hatched Artemia nauplii (one day old) were used in (i) starvation and (ii) pathogen challenge tests. These tests were designed to elucidate the effects of different supplements, from individual chemicals such as PHB and chitosan to CP-ZD1, on the growth, survival, immune response, and the gut microbiome of the Artemia.

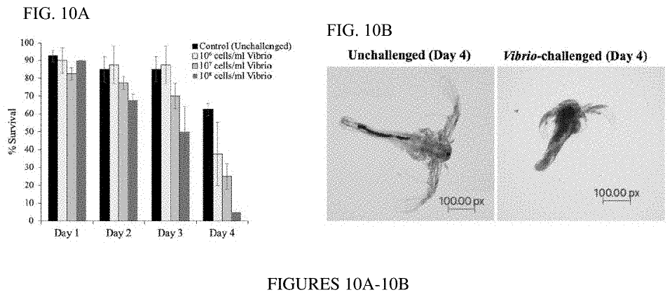

The starvation tests were conducted to examine whether the supplemental feeds (crystalline PHB, chitosan, PHB+chitosan (1:1 w/w), ZD1 biomass containing 60% or 75% of PHB (hereafter P60-ZD1 and P75-ZD1), and chitosan-harvested 60% or 75% PHB-rich ZD1 (hereafter CP60-ZD1 and CP75-ZD1)) can be used as a feed/energy source for the starved Artemia, affect Artemia's survival, and modify Artemia's gut microbiome. Survival after receiving the individual feed would indicate that the supplemented feed can serve as a feed/energy source for the starved Artemia. The pathogen challenge tests were designed to determine the effects of these supplements on the survival and immune response of Vibrio-challenged Artemia. The challenge lethal dose (10⁸ cells/ml) was determined by performing preliminary experiments challenging Artemia with different concentrations of V. campbellii (10⁶-10⁸ cells/ml) and recording the survival of Artemia (FIG. 10A-B).

Analysis of Immune-Related Genes Expression and Gut Microbiome in Artemia. The expression of immune-related genes (heat shock protein (hsp70), ferritin (ftn), and peroxinectin (pxn)) and housekeeping gene (actin) in Artemia samples (˜60 mg) from the pathogen challenge tests was assessed using quantitative real time-polymerase chain reaction (RT-qPCR), with some modifications. Details of the RT-qPCR and the primer sets (Table 10) are provided.

The gut microbiome of the Artemia obtained from the starvation tests was sequenced using Illumina MiSeq sequencing (Texas A&M Institute for Genome Sciences and Society, USA). Details of DNA extraction, sequencing, and data processing are provided herein. The raw sequences have been deposited to BioProject accession number PRJNA765685 in the NCBI BioProject database. The abundance of genes coding enzymes involving PHB or chitosan degradation in Artemia's gut microbiome were identified and predicted from amplicon sequence variants (ASVs) using Tax4Fun2 version 1.1.5. Also, the abundance of Vibrio spp. in Artemia and total bacteria were determined using qPCR. See Table 10 for the primer sets.

TABLE 10
Primer sets used for immune response analysis in
Artemia by RT-qPCR (Norouzitallab et al., 2016).
Heat shock protein 70 (hsp70), ferritin (ftn),
peroxinectin (pxn), and β-actin. Primer
sets used for relative abundance of Vibrio spp.
and total bacteria by qPCR.

| Gene | Primer | Sequence (5′-3′) |
|---|---|---|
| hsp70 | Forward | cgataaaggccgtctctcca |
| | Reverse | cagcttcaggtaacttgtccttg |
| ftn | Forward | tccaaggcttatccgatgaaca |
| | Reverse | atgaccaagtgagtgcttctct |
| pxn | Forward | gagctaccgatgaagatccag |
| | Reverse | cgtttcctgaacagcgaataaa |
| β-actin | Forward | agcggttgccatttcttgtt |
| | Reverse | ggtcgtgacttgacggactatct |
| Vibrio spp. | Forward | cggtgaaatgcgtagaga |
| 16S rRNA | Reverse | ttactagcgattccgagttc |
| Total bacteria | Forward | atggctgtcgtcagct |
| 16S rRNA | Reverse | acgggcggtgtgtac |

### Example 8

### Antimicrobial Properties of 3-HB, COS, and 3-HB+COS

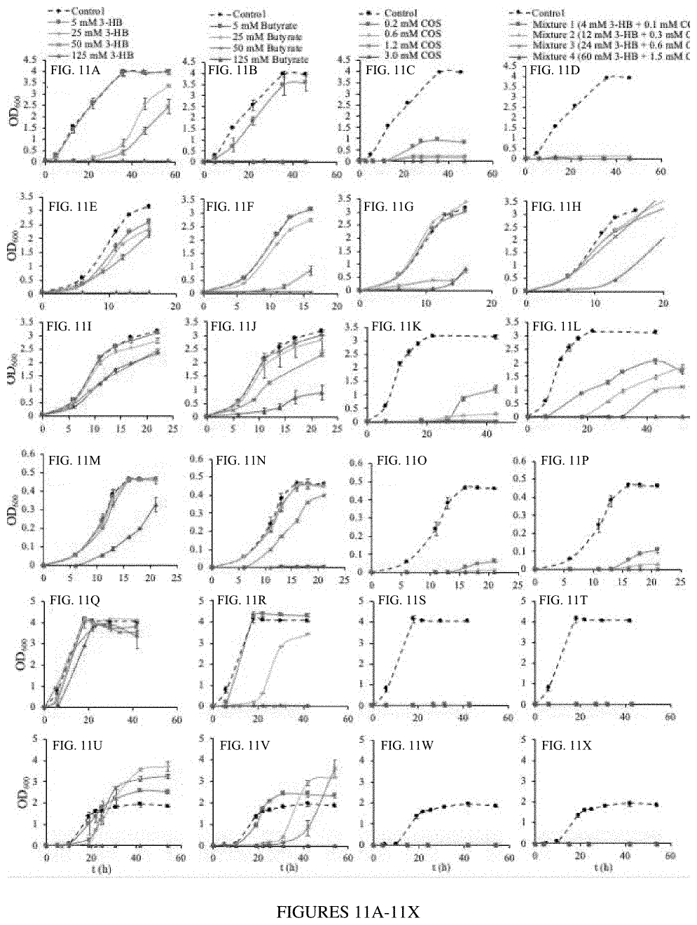

Growth Inhibition Toward G− and G+ Bacteria and three Aquaculture Pathogens. Growth inhibition of non-pathogens and three known aquaculture pathogens was observed in the presence of PHB intermediates (3-HB and butyrate), chitosan intermediate (COS), and a mixture of 3-HB+COS (FIG. S2), with higher inhibition as concentrations increased. Generally, the PHB intermediates (3-HB and butyrate) showed stronger inhibitory effects on aquaculture pathogens (V. campbellii, A. hydrophila, and S. agalactiae) than on non-pathogens (E. coli, B. megaterium, and RHA1), and COS showed more inhibitory effects on non-pathogens than pathogens (FIG. 11).

Low concentrations of PHB intermediates (50-125 mM of 3-HB or 25-50 mM of butyrate) showed a significant inhibitory effect on G− strains (V. campbellii and A. hydrophila) than on G+ strain (S. agalactiae) (FIGS. 11A and E and FIGS. 11M and N). Additionally, no significant inhibition effects on E. coli, B. megaterium, and RHA1 were observed; the latter two strains used PHB intermediates as additional C-sources (FIG. 11). Interestingly, low concentrations of COS (<1.2 mM) showed significant antimicrobial properties toward G+ strains (S. agalactiae, B. megaterium, and RHA1) (FIGS. 11O, S, and W). On the contrary, much higher COS concentrations (>1.2 mM) were required to inhibit the growth of G− strains, V. campbellii and E. coli (FIGS. 11C and K). A. hydrophila was not inhibited even at higher COS concentrations (>3 mM COS) (FIG. S2G), which might be explained by the ability of A. hydrophila to secrete chitinolytic enzymes that can effectively degrade chitin and chitosan for their growth (Zhang et al., 2015).

Mixtures with low concentrations of 3-HB and COS effectively inhibited the growth of all tested strains, suggesting combined antimicrobial effects of 3-HB and COS (FIG. 11). While the individual 25-mM 3-HB or 0.6-mM COS was not effective, Mixture 2 containing 12-mM 3-HB and 0.3-mM COS effectively inhibited all tested strains, except A. hydrophila. As A. hydrophila grew in Mixture 4 (60-mM 3-HB+1.5-mM COS), higher concentrations of both compounds are needed to inhibit the growth (FIG. 11H).

TABLE 4
MICs and IC50 (mM) of 3-HB, butyrate, COS, and 3-HB + COS against various
Gram-negative and Gram-positive bacterial strains.

| | | Gram-negative strains | | | Gram-positive strains | | |
|---|---|---|---|---|---|---|---|
| Compound | Parameter | V. campellii | A. hydrophila | E. coli | S. agalactide | B. megaterium | R. jostii RHA1 |
| 3-HB | MIC | 111.5 | 133 | 510 | 945 | N.I. | N.I. |
| | IC₅₀ | 53 | 57.7 | 223.5 | 493.4 | N.I. | N.I. |
| Butyrate | MIC^{a} | 25.7 | 118 | 179 | 135 | 53 | N.I. |
| | IC₅₀^{b} | 3.82 | 39.7 | 61.2 | 83.4 | 26.2 | N.I. |
| COS | MIC | 2.36 | N.I. | 1.88 | 1.08 | <0.2^{c} | <0.2 |
| | IC₅₀ | 0.07 | 0.74 | 0.08 | 0.16 | N.A. | N.A. |
| 3-HB + COS [symbol] | MIC | <4 ± 0.1 | N.I. | 72 ± 1.8 | 22 ± 0.55 | <4 ± 0.1 | <4 ± 0.1 |
| | IC₅₀ | 0.20 ± 0.01 | 30.56 ± 76.1 | 9.30 ± 0.23 | 2.69 ± 0.07 | N.A. | N.A. |

^{a}MIC was determined by taking regression through the highest optical densisties measured at different compound concentration. ^{b}IC₅₀ was estimated by taking regression through % inhibition efficiencies calculated in Table S2 in the Supporting Information (SI) to fit the 4-parameter logistics model (Sebaugh, 2011). [symbol] symbol was provided when total inhibition was reached within low tested concentrations. ^{d}Concentrations were determined based on test Mixtures 1-4 of 3-HB + COS. 3-HB = 3-hydroxybutyrate; COS = chitosan oligosaccharides; N.I. = no inhibition; N.A. = not applicable (strains have already exhibited full inhibition at the lowest compound concentration). Data presented were the average from the duplicate measurements. All standard deviations were below 10%. [symbol]
indicates data missing or illegible when filed

TABLE 5
Inhibition efficiencies of 3-HB, butyrate, COS, and 3-HB + COS against
various Gram-negative and Gram-positive bacterial strains.

| | | Inhibition Efficiency (%)^{a} | | | | | |
|---|---|---|---|---|---|---|---|
| | Concentration | Gram-negative strains | | | Gram-positive strains | | |
| Compound | (mM) | V. campellii | A. hydrophila | E. coli | S. agalactide | B. megaterium | R. jostii RHA1 |
| 3-HB | 0 (Control) | 0 | 0 | 0 | 0 | 0 | 0 |
| | 5 | 1.27 ± 1.07 | 2.7 ± 1.26 | 2.68 ± 0.67 | 0.75 ± 0.01 | 6.52 ± 3.48 | −32.3 ± 2.20 |
| | 25 | 14.0 ± 1.78 | 24.1 ± 2.70 | 9.15 ± 3.12 | 0.75 ± 0.03 | −1.35 ± 1.04 | −87.3 ± 4.00 |
| | 50 | 42.4 ± 5.88 | 31.1 ± 3.59 | 24.5 ± 2.23 | 0.75 ± 0.01 | 12.9 ± 0.94 | −61.7 ± 0.58 |
| | 125 | 100 | 100 | 26.5 ± 1.34 | 13.8 ± 0.15 | 17.0 ± 14.4 | 100 |
| Butyrate | 0 (Control) | 0 | 0 | 0 | 0 | 0 | 0 |
| | 5 | 9.14 ± 8.90 | 0.80 ± 0.22 | 5.0 ± 0.89 | 0.75 ± 0.01 | −5.80 ±1.74^{b} | −25.2 ± 4.93 |
| | 25 | 100 | 12.7 ± 1.80 | 10.7 ±12.0 | 0.43 ± 0.15 | 15.5 ± 1.56 | −70.8 ± 2.65 |
| | 50 | 100 | 72.4 ± 5.40 | 23.0 ± 6.24 | 10.2 ± 1.83 | 100 | −92.2 ± 21.6 |
| | 125 | 100 | 100 | 71.1 ± 8.25 | 100 | 100 | 100 |
| COS | 0 (Control) | 0 | 0 | 0 | 0 | 0 | 0 |
| | 0.2 | 76.5 ± 1.13 | 4.81 ± 0.11 | 60.6 ± 4.56 | 80.9 ± [symbol] | 100 | 100 |
| | 0.6 | 93.0 ± 1.10 | −7.30 ± 0.40 | 90.6 ± 0.91 | 95.4 ± 0.01 | 100 | 100 |
| | 1.2 | 95.0 ± 0.23 | 77.6 ± 0.28 | 100 | 100 | 100 | 100 |
| | 3 | 100 | 74.2 ± 0.61 | 100 | 100 | 100 | 100 |
| 3-HB + COS | 0 (Control) | 0 | 0 | 0 | 0 | 0 | 0 |
| Mixture 1 | 0.1 ± 4 | 94.2 ± 0.17 | 15.2 ± 1.39 | 33.2 ± 3.65 | 66.5 ± 5.60 | 100 | 100 |
| Mixture 2 | 0.3 ± 12 | 96.4 ± 0.17 | 10.7 ± 4.84 | 52.4 ± 2.50 | 91.4 ± 0.03 | 100 | 100 |
| Mixture 3 | 0.6 ± 24 | 100 | −10.5 ± 0.70 | 68.7 ± 0.91 | 100 | 100 | 100 |
| Mixture 4 | 1.5 ± 60 | 100 | 24.5 ± [symbol] | 100 | 100 | 100 | 100 |

^{a}% Inhibition efficiencies were determined using Eq. (1) that considers the highest optical densities in relevant to the control (i.e. strains cultivated without PHB or chitosan intermediates). Data were presented (average ± SD) from duplicate measurements. ^{b}Negative efficiency means that the strain grew more than the control. 3-HB = 3-hydroxybutyrate; COS = chitosan oligocaaccharide. [symbol]
indicates data missing or illegible when filed

Table 4 summarizes the MIC and IC₅₀ of 3-HB, butyrate, COS, and 3-HB+COS. By taking the regression through the highest OD₆₀₀ in FIG. 11, the percentage inhibition efficiencies were listed (Table 5) and used to fit a 4-parameter logistic model (FIG. 11) to estimate IC₅₀. For V. campbellii and A. hydrophila, similar MIC and IC₅₀ of 111.5-133 and 53-58 mM of 3-HB, respectively; however, much lower MICs and IC₅₀ values of butyrate (25.7-118 and 5.8-39.7 mM) were observed (Table 4). Again, as indicated by the lower MICs and IC₅₀ values, COS had stronger antimicrobial effects on G+ strains than G− strains, and the mixtures of 3-HB+COS had much lower MICs and IC₅₀ compared to individual 3-HB and COS (Table 4). Similarly, the biplot based on IC₅₀ values (FIG. S4) revealed that G+ bacteria were more sensitive to COS. Specifically, pathogenic S. agalactiae was more susceptible, i.e., located far from COS and mixtures, whereas A. hydrophila was far less suspectable (i.e., located closer to COS or 3-HB+COS). Particularly, butyrate and 3-HB showed better inhibitory effects toward G− pathogens (i.e., V. campbellii and A. hydrophila located far) but not as effective toward G+ pathogen S. agalactiae.

New Perspectives of Antimicrobial Properties of 3-HB, Butyrate, and COS. For the first time, this study demonstrated that PHB intermediates not only inhibited aquaculture pathogens but also non-pathogens, such as E. coli, B. megaterium, and RHA1. Without being bound by any theory, a higher antimicrobial efficacy against pathogens could be attributed to the ability of PHB intermediates to limit the phenotypic expression of pathogens' virulence factors. For example, PHB intermediate (3-HB) reduced Vibrio's motility that was mediated by flagella and pili adhesion factors and inhibited expression of bioluminescence, hemolysin, and quorum-sensing compounds that led to disruption of biofilm formation. Butyrate, with the same pKₐ (4.82) as 3-HB, is an effective SCFA against enterobacteria. Without being bound by any theory, the stronger inhibition activity of PHB intermediates against G− strains (e.g., V. campbellii and A. hydrophila) could be attributed to the higher diffusion of the intermediates through the thin peptidoglycan layer of G− cell wall, while hindered by the thick peptidoglycan layer of G+ strains.

These observations are consistent with previous studies reporting that COS and chitosan effectively inhibited common warm-water finfish pathogens (e.g., A. hydrophila, Edwardsiella ictaluri, Flavobacterium columnare, and S. agalactiae), cold-water fish pathogen (Aliivibrio salmonicida), and common Vibrio species that infect crustaceans. Without being bound by any theory, it has been suggested that the positively charged amino group of COS and chitosan could adsorb onto the negatively charged bacterial cell wall, leading to cell disruption, leakage of intercellular components, and/or blockage of DNA synthesis. Without being bound by any theory, COS and chitosan have been suggested to bind with teichoic acid in the peptidoglycan layer of G+ strains, or chelate with metal cations and/or interact with anions in the outer lipopolysaccharide of G− strains. In this study, a slightly higher inhibition effect of COS on G+ than G− strains was observed. Previous studies reported chitosan exhibited a broad-spectrum against various microorganisms and strain types. Without being bound by any theory, the discrepancy could stem from varying chitosan properties, such as molecular weight and degree of deacetylation and polymerization.

The mixture of 3-HB+COS at low doses strongly inhibited the growth of aquaculture pathogens, particularly V. campbellii and S. agalactiae. Without being bound by any theory, the enhanced inhibitory effect could be attributed to the combined inhibitory mechanisms elicited by PHB and chitosan intermediates as described above. Furthermore, the low pH in aquatic animals' guts (average pH 5.9-6.7 in Artemia), particularly after feeding PHB could increase the concentration of undissociated fatty acids in the cells and thus improve the antimicrobial efficacy of PHB intermediates. Without being bound by any theory, the low pH environment could also boost higher positive amino charges in chitosan, magnifying the antimicrobial properties and cutting down the MICs. Thus, the mixture of 3-HB+COS combats bacteria and pathogens and vitalizes other beneficial microbes, leading to improvement of the microbiome in aquatic animals. Without being bound by any theory, these results could suggest that the co-application of chitosan with PHB could outperform PHB or chitosan alone to promote survival and disease resistance of aquaculture.

### Example 9

### Chitosan-Harvested PHB-Rich ZD1 (CP-ZD1) as an Effective Feed/Energy Source for Artemia

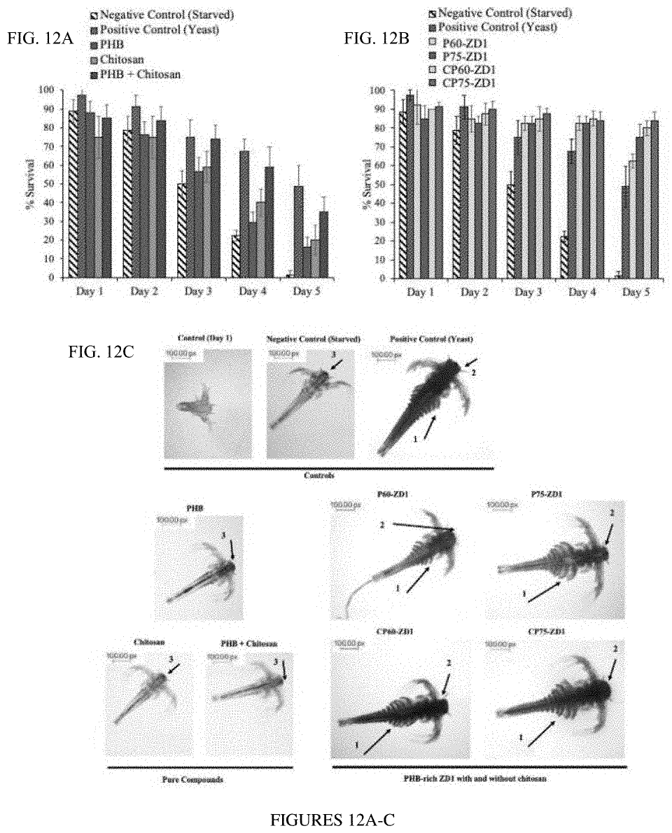

The survival of the starved Artemia with or without receiving supplements was used to assess if the supplements can be used as feed/energy sources by the starved Artemia. After five days of incubation, only 5% survival was observed in the negative controls (i.e., starved unfed Artemia) and 48% in the positive controls (i.e., yeast-fed Artemia) (FIG. 12A). The survival, from low to high, was 16% for crystalline PHB-fed Artemia<20% for chitosan-fed Artemia<35% for crystalline PHB+chitosan (1:1 w/w)-fed Artemia<63-75% for P-ZD1-fed Artemia<85% for CP-ZD1-fed Artemia (FIG. 12B), which was about 1.7-fold higher than the yeast-fed Artemia.

Without being bound by any theory, the high survival of starved Artemia when supplied with P-ZD1 and CP-ZD1 than with yeast could suggest that ZD1 biomass could be utilized as an effective and better feed/energy source for Artemia. This could be attributed to ZD1's simple and more digestible cell wall compared to yeast's cell wall, which is characterized to be rough (i.e., comprises 25-30% of dry matter) with complex heteropolysaccharides, mannoprotein, and glucan, all of which complicating yeast's digestibility. Additionally, ZD1 biomass contains essential nutrients (e.g., proteins, lipids, and minerals) that contribute as energy content and lead to lipid deposition in aquatic animals' tissues, including Artemia. A positive link between the PHB content in ZD1 (i.e., 75% PHB in CDW compared to 60% PHB) and the survival rate of the P-ZD1-fed Artemia was observed, regardless of the presence of chitosan (i.e., use of chitosan for ZD1 harvesting). Without being bound by any theory, this could be also explained by the property of PHB being a biopolymer of SCFAs (3-HB and butyrate); hence, PHB acts as an additional energy source, improving the survival of Artemia fed with pure crystalline PHB (FIG. 12A).

Positive effects of chitosan were supported by the higher survival of Artemia fed with pure chitosan or with PHB+chitosan (FIG. 12A) and CP-ZD1 (FIG. 12B) and much developed and healthier Artemia receiving CP-ZD1 (FIG. 12C). The Artemia fed with CP-ZD1 had an advanced nauplii life stage developing rudimentary thoracopods, primordial bilateral compound eyes, and a longer body length (FIG. 12C). Also, CP-ZD1-fed Artemia showed a darker color because of higher tissue development, indicating greater thickness and density of Artemia tissues. These observations are consistent with previous findings that have reported chitosan in aquacultural diet improved disease resistance, growth, and nutrient digestion. Chitosan contains 5-8% N (depending on the deacetylation degree) which are the building blocks of proteins, and chitosan degradation products such as oligosaccharides and functional groups (amino, carbonyl, amido, and hydroxyl) have been reported to incorporate into glycosaminoglycans and glycoproteins. Accordingly, without being bound by any theory, chitosan could contribute to protein content and/or serve as an energy source for Artemia as observed in this study.

### Example 10

### Chitosan-Harvested PHB-Rich ZD1 (CP-ZD1) as an Effective Immune-Stimulating Feed

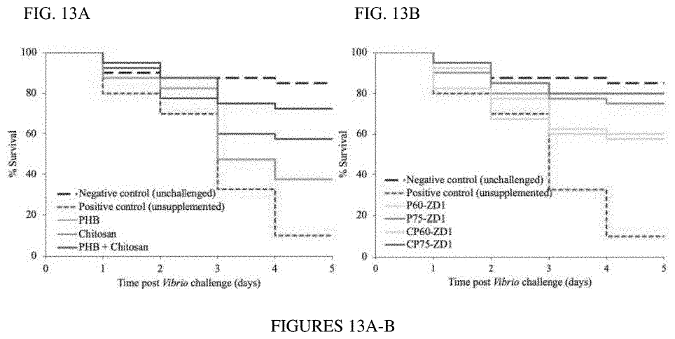

Enhance Pathogen Resistance in Artemia. The effects of different supplements on the survival of Vibrio-challenged yeast-pre-grown Artemia were shown in FIG. 13. The survival of unchallenged Artemia on day 5 was 85%. The survival from low to high was as follows: 10% for the positive control (i.e., unsupplemented Vibrio-challenged Artemia)<40% for chitosan-supplemented<60% for pure PHB-supplemented<60-70% for P-ZD1-supplemented<60-80% for CP-ZD1-supplemented. The results indicated the superiority of CP-ZD1 biomass in protecting Artemia against Vibrio infection.

Without being bound by any theory, the higher survival of V. campbellii-challenged Artemia when fed CP-ZD1 could be contributed by a combination of the antimicrobial and immune-stimulating effects triggered by the presence of PHB and chitosan in Artemia. This observation is supported by the low MIC and IC₅₀ of 3-HB, butyrate, COS, and 3-HB+COS mixtures listed in Table 4. As discussed previously, V. campbelli was the most susceptible strain to PHB and chitosan intermediates, particularly after combining 3-HB+COS. Therefore, PHB and chitosan in CP-ZD1 could have been biodegraded in the Artemia's gut into their intermediates (i.e., 3-HB, butyrate, COS), leading to higher resistance to V. campbelli invasion. In fact, it has been reported that ˜24 mM (2.5 g/L) of 3-HB was released in Artemia's gut after feeding 1 g/L of PHB. Considering CP75-ZD1 treatment in this study, the biodegradation could theoretically release ˜1.88 g/L (i.e., 18 mM) of 3-HB. Thus, feeding CP75-ZD1 (with ˜0.75 g/L PHB and ˜0.05 g/L chitosan) is about 17 and 300 times more efficient than 3-HB and COS antimicrobial concentrations toward V. campbelli (Table 4).

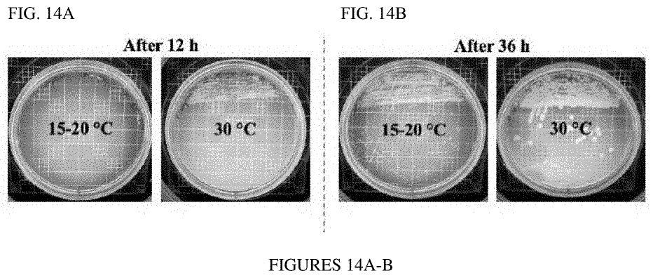

The survival of Vibrio-challenged Artemia observed in this study was consistent with those reported in the literature. However, previous studies reported survival rates after two days of challenge; whereas, it took four to five days to reach the same survival rate in this study. Without being bound by any theory, slower infection and mortality rate in this study could have resulted from a lower culturing temperature at 20° C. compared to the 30° C. as previously tested. This condition was nonideal for V. campbelli to grow, leading to a slower growth rate (FIG. 14).

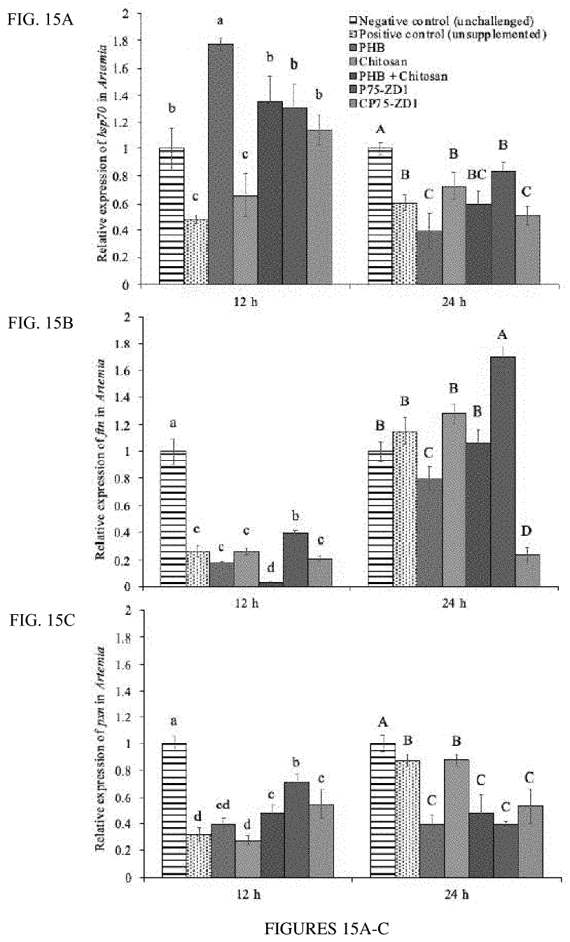

Effects on the Immune Response in Artemia. The expression of defensive genes (hsp70, ftn, and pxn) in Vibrio-challenged Artemia supplemented with different treatments is shown in FIG. 15. The relative expression of hsp70 in pure PHB-supplemented Artemia after 12 hours was higher than the negative controls (i.e., unchallenged Artemia) (FIG. 15A). While Artemia supplemented with P-ZD1 and CP-ZD1 had a relatively higher hsp70 expression (1.2-1.6 fold) after 12 h, but decreased after 24 hours to a similar level as that of the controls. An opposite trend was observed for the expression of ftn and pxn. For ftn, the relative expression was downregulated in all treatments after 12 hours with a significant decrease in the PHB+chitosan treatment, and then increased to the control levels after 24 hours (FIG. 15B). Interestingly, ftn expression in CP-ZD1-supplemented Artemia remained downregulated even after 24 h. Similarly, the relative expression of pxn was declined (0.4-fold) in all treatments after 12 h. However, no significant difference among the treatments was observed, and the same trend remained for all the treatments even after 24 hours (FIG. 15C).

Invertebrates such as Artemia lack adaptive immunity and depend on their innate immune system, i.e., expressing stress- and immune-related genes when facing pathogens. Studies have suggested that chitosan can trigger innate immune responses and improve hematological parameters. For instance, supplementing chitosan in fish and crustacean diets enhanced phagocytic and lysozyme activities, regulated antioxidant enzyme activities, and reduced lipid oxidation in shrimps. Similarly, PHB has been shown to stimulate innate (nonspecific) genes in Artemia due to cellular acidification induced by 3-HB.

Among various innate responses, hsp70, ftn, and pxn have been suggested as the most important defensive genes in many invertebrates, without being bound by any theory. Previous studies have suggested that PHB stimulated the expression of a stress-response gene encoding heat shock protein 70 (hsp70), which in turn regulates other immune-related genes in aquatic animals against pathogens. Consistent with previous reports, higher expressions of hsp70 in Vibrio-challenged Artemia supplemented with P-ZD1 and CP-ZD1 were observed, and specifically in pure PHB-supplemented Artemia. Without being bound by any theory, this observation could confirmed that PHB might play a key role in increasing disease resistance and improving Artemia's survival. However, chitosan alone appeared not to affect the expression of hsp70 after 12 hours or 24 hours (FIG. 15A). Interestingly, a slight reduction of hsp70 expression was observed for Artemia supplemented with both chitosan and PHB (i.e., PHB vs. PHB+Chitosan and P-ZD1 vs. CP-ZD1).

Downregulation of ftn gene encoding ferritin protein was observed, and without being bound by any theory, this could confirm the defensive strategy of the host (Artemia) to deprive iron required for the growth of pathogens. The prolonged ftn downregulation in CP-ZD1-supplemented Artemia could explain the higher survival observed in the challenged Artemia. However, the results show that ftn gene expression is not stable. Without being bound by any theory, this could be attributed to the characteristics of ftn gene that could be only stable for a short period post pathogenic challenge. It could also be attributed to the expression of other stress- and immune-related genes, which could have overshadowed ftn gene expression. As the exact underlying mechanisms of supplements on immune response and gene expression are complicated, more research is needed to analyze other defensive genes, focusing on the immune response at different times and life stages of Artemia. The pxn gene encoding peroxinectin protein, a multifunctional immune component involved in various biological processes, showed no significant gene expression changes, indicating there was no association between the pxn gene and the supplement feed and/or the Vibrio challenge, without being bound by any theory. Overall, the results suggest that supplementing amorphous PHB, particularly CP-ZD1, could be utilized to induce the expression of defensive genes in Artemia to resist pathogen Vibrio.

### Example 11

### Chitosan-Harvested PHB-Rich ZD1 (CP-ZD1) Shaped a Healthier Artemia Gut Microbiome

Microbial Community Compositions in Artemia Gut: Diversity and Abundance. The gut microbial community of Artemia fed with CP-ZD1 was more diverse than that of the Artemia fed with pure PHB+chitosan, according to the high values of diversity indices (Simpson and Shannon=0.94-0.95 and 4.61-4.78 vs. Simpson and Shannon=0.79 and 3.31) (Table 6). Similarly, the Chao1 index was the highest (72.05-73.37) for the CP-ZD1-fed Artemia. The values of the Faith phylogenetic diversity index (i.e., Faith PD index) also supported the link of the degree of diversity to different feed supplements, from low to high, P-ZD1-fed (Faith PD of 3.08-3.96)<CP-ZD1-fed (Faith PD of 4.66-4.97)<PHB+chitosan-fed (Faith PD of 7.08). No significant difference in diversity was observed among those fed with ZD1 biomass with different PHB contents (i.e., P60-ZD1, P70-ZD1, CP60-ZD1, and CP70-ZD1).

TABLE 6
Diversity indices of gut microbiome of Artemia fed
with different treatments at 20,000 sequence depth.

| Feeding type | Simpson | Shannon | Chaol | Faith PD |
|---|---|---|---|---|
| PHB + chitosan | 0.79 | 3.31 | 69.00 | 7.08 |
| P60-ZD1 | 0.94 | 4.50 | 56.90 | 3.08 |
| P75-ZD1 | 0.95 | 4.70 | 74.15 | 3.96 |
| CP60-ZD1 | 0.95 | 4.78 | 72.05 | 4.97 |
| CP75-ZD1 | 0.94 | 4.61 | 73.37 | 4.66 |

TABLE 7
Relative abundance (%) of total G+, G−,
Gram-variable, and unknown bacterial populations.

| | Gram- | Gram- | Gram- | |
|---|---|---|---|---|
| | positive | negative | variable | |
| Feeding type | bacteria | bacteria | bacteria [symbol] | Unknown |
| PHB + chitosan | 86.1 | 7.64 | 6.15 | 0.11 |
| P60-ZD1 | 99.5 | 0.51 | 0 | 0 |
| P75-ZD1 | 99.8 | 0.21 | 0 | 0 |
| CP60-ZD1 | 98.6 | 1.30 | 0.09 | 0.01 |
| CP75-ZD1 | 98.9 | 0.96 | 0.71 | 0.01 |

[symbol]

Four ASVs associated with Gram-variable bacteria belong to Paenibacillus uliginis. [symbol]
indicates data missing or illegible when filed

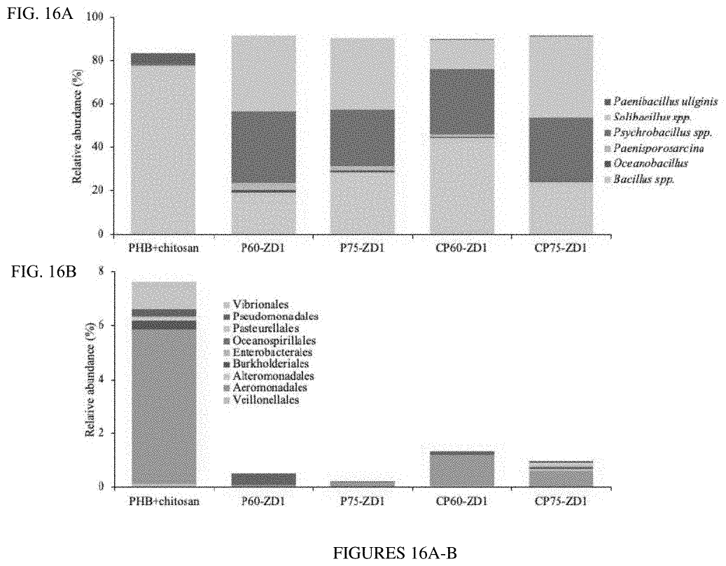

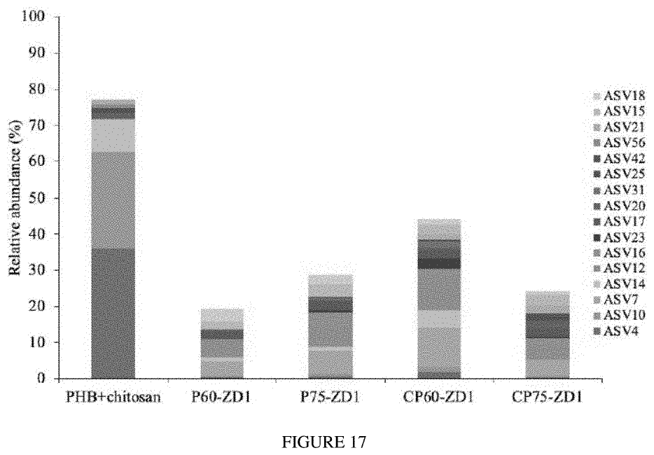

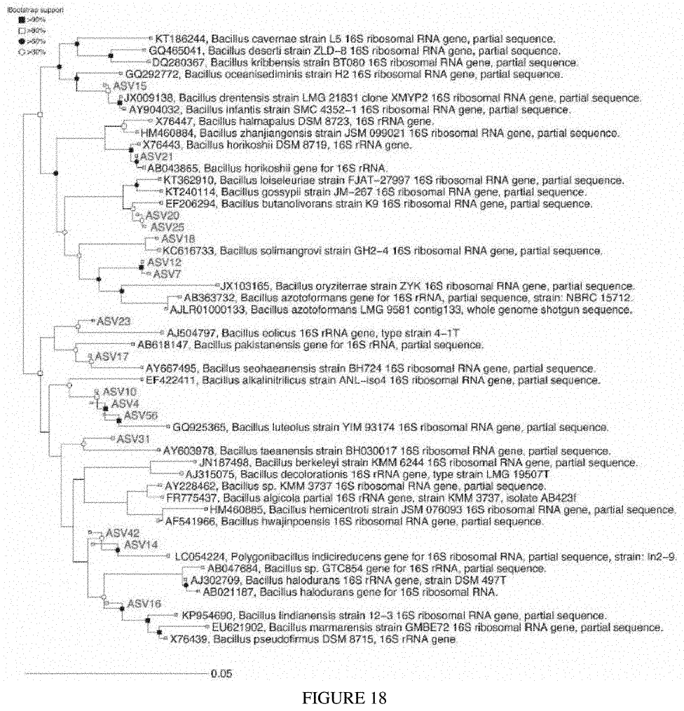

Among 251 of total retrieved amplicon sequence variants (ASVs), 188 of ASVs were G+ bacteria, suggesting that G+ bacteria were dominant in Artemia received all feeding treatments. Artemia fed with P-ZD1 and CP-ZD1 had higher G+ bacteria (99.5-99.8%) than Artemia fed PHB+chitosan (86.1%) (Table 7 and FIG. 16A). The microbiome in Artemia fed with PHB+chitosan had high populations of G+Psychrobacillus and Solicibacillus but a low population of Bacillus (FIG. 16A). Interestingly, three Bacillus-associated ASVs (i.e., ASV4, 10, and 14) decreased from 36.1, 26.2, and 9.1% to 1.7, 1.4, and 4.7%, respectively; while the other seven Bacillus-associated ASVs (i.e., ASV7, 12, 16, 17, 31, 15, and 18) increased compared to those receiving PHB+chitosan treatment (FIG. 17). Among them, ASV15 and ASV18 were identified to be closely related to B. infantis and B. solimangrovi (FIG. 18). ASV21, closely related to B. horikoshii, significantly increased in chitosan-containing treatments, i.e., CP-ZD1 and PHB+chitosan (FIG. 17).

For G− bacteria-associated ASVs, a total of nine different order-level populations were detected (FIG. 16B), with a significantly lower abundance than G+ bacteria. The highest abundance of G− bacteria was observed in Artemia fed with PHB+chitosan (7.64%), followed by that fed with CP-ZD1 (0.96-1.3%) and that fed with P-ZD1 (0.21-0.51%) (Table 7 and FIG. 16B). However, compared to PHB+chitosan, Aeromonadales and Burkholderiales decreased significantly in the P-ZD1 treatments (i.e., from 5.8% to 0.13%), but not as rapid in the CP-ZD1 treatments (i.e., from 5.8% to 1.2%). Vibrionales were not detected in all treatments, except in the PHB+chitosan treatment. Four ASVs were identified to be Gram-variable bacteria, Paenibacillus uliginis. However, these four ASVs were only present in chitosan-containing treatments such as PHB+chitosan (6.15%) and CP-ZD1 (0.17%).

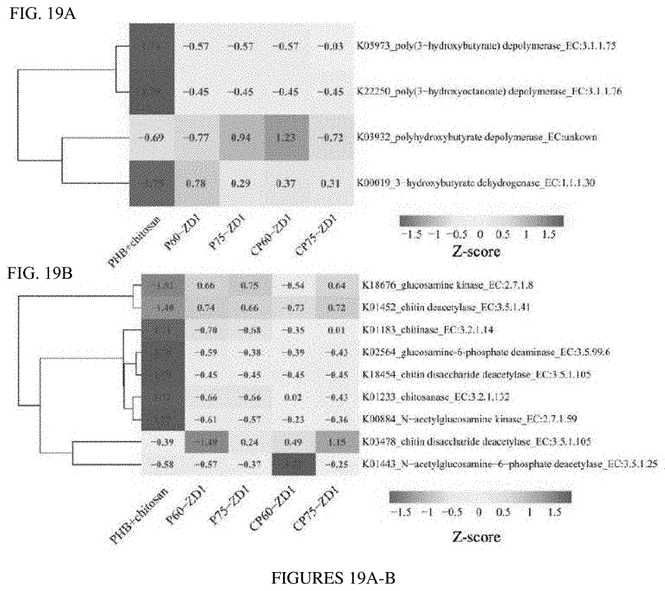

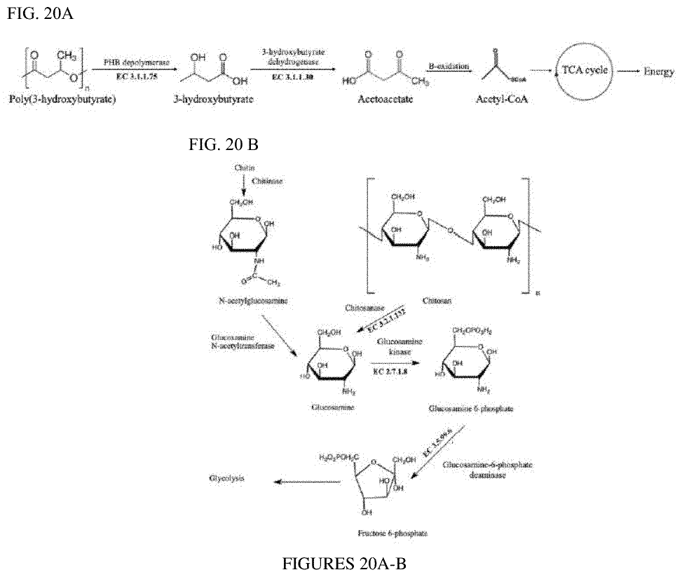

Prediction of PHB or Chitosan Degradation in Artemia's Gut Microbiome. As PHB and chitosan are biodegradable, the diversity and abundance of different microbial populations in the gut microbiome might be shaped differently depending on the abundance of PHB or chitosan degradation genes in the Artemia's gut microbiome. Using Tax4Fun2, the abundance of genes coding enzymes involved in the PHB degradation (i.e., PHB depolymerase (KO:K05973; EC 3.1.1.75), poly(3-hydroxyoctanoate; 3-HO) (PHO) depolymerase (KO:K00019; EC 3.1.1.76), and 3-HB dehydrogenase (KO:K00019; EC 1.1.1.30) and polyhydroxyalkanoates depolymerases (EC 3.1.1.75 and EC 3.1.1.76) were identified (FIG. 19A). Pathway and enzymes involving PHB biodegradation are shown in FIG. 20A. PHB and PHA depolymerases catalyze the hydrolysis of the polymer to mono- and/or oligomeric hydroxyalkanoic acids (3-HB and 3-HO), which can be subsequently utilized as a source of carbon and energy by microorganisms. 3-HB dehydrogenase catalyzes the reversible oxidation of 3-HB to acetoacetate, which then yields two molecules of acetyl-CoA that are metabolized via the tricarboxylic acid cycle, providing energy. The high abundance of PHA depolymerization enzymes (i.e., PHB and PHO depolymerase) in pure PHB+chitosan treatments could be supported by the higher Z-scores of 1.74-1.79 of Z-tests (this Z-score signifies the abundance of PHB and chitosan degradation genes). Also, 3-HB dehydrogenase was relatively evenly distributed for CP-ZD1 and P-ZD1 treatments (Z-score=0.29-0.78), but higher than PHB+chitosan treatment (Z-score=−1.75). Without being bound by any theory, these could suggest the production of 3-HB in the gut microbiome of Artemia receiving amorphous PHB (i.e., P-ZD1 and CP-ZD1).

Similarly, the abundance of chitosan- and chitin-degradation genes coding chitosanase (KO:K05973; EC 3.2.1.132), glucosamine kinase (KO:K18676; EC 2.7.1.8), and glucosamine 6-phostphate deaminase (KO:K02564; EC 3.5.99.6) were identified (FIG. 19B). As shown in FIG. 20B, chitosanases are glycosyl hydrolases that endohydrolytically cleave β-1,4-glycosidicbonds between monomers to release COS, glucosamine kinase converts glucosamine to glucosamine 6-phosphate, and glucosamine-6-phosphate deaminase catalyzes the reversible conversion of glucosamine-6-phosphate into fructose-6-phosphate and ammonia. A higher abundance of chitosanase and glucosamine kinase was detected in PHB+chitosan treatment (FIG. 19B), potentially explained by the direct exposure to pure chitosan without being bound by any theory. Higher abundance of chitosanase (i.e., higher Z-scores (−0.43-0.02)) for CP-ZD1-supplemented samples than for P-ZD1-supplemented samples (Z-score of −0.66) was observed, and without being bound by any theory, this could be attributed by the production of COS in the gut microbiome of Artemia receiving chitosan-containing treatments. Furthermore, a higher abundance of genes encoding chitinase (KO:K01183) and chitin disaccharide deacetylase (KO:K03478) was observed in chitosan-containing treatments. Without being bound by any theory, this could be explained by the presence of P. uliginis str. N3/975^{T} and B. horikoshii str. a20 in the gut microbiome, which were identified to possess chitinase (accession #: WP_208919439 and WP_208914389) and chitin disaccharide deacetylase (accession #: WP_088017227), respectively.

Possible Links Among Gut Microbiome, PHB/Chitosan Degradation Genes, Feed Supplements, and Survival of Artemia. The higher microbial diversity observed in Artemia fed with CP-ZD1 or P-ZD1 is due to the increased richness of Bacillus spp. and the appearance of closely related Psychrobacillus and Solibacillus spp. Without being bound by any theory, this higher diversity could have been facilitated due to the effectiveness of amorphous PHB being more readily biodegradable (i.e., smaller size, lower crystallinity, and surrounded by phospholipids and proteins) and concurrently supplied with enriched nutrients in ZD1 biomass. In contrast, the low microbial diversity in Artemia fed with pure crystalline PHB+chitosan could be due to the significant dominance of a few Bacillus spp. (ASV4, ASV10, and ASV14) that have been propagated due to their ability to directly degrade crystalline PHB and the higher antimicrobial properties of PHB intermediates toward G− strains. Notably, Artemia fed with CP-ZD1 and P-ZD1 led to a healthier gut microbiome in terms of higher microbial diversity and abundance of beneficial bacteria, such as Bacillus spp., Lactobacillus, Lactococcus, and Paenibacillus. Without being bound by any theory, the chitosan in CP-ZD1 could have also contributed to the diversity and composition of the microbial community. Interestingly, P. uliginis and B. horikoshii were only observed in chitosan-containing treatments, suggesting the important role of chitosan-degrading strains other than chitosanase-harboring Bacillus spp. and the beneficial effects of chitosan in the diet.

The functional prediction analysis indicated the higher abundance of PHB and chitosan degradation genes in Artemia's gut microbiome, particularly in the pure PHB+chitosan treatment. Without being bound by any theory, the presence of pure PHB and chitosan could have promoted the microbiome with relevant PHB depolymerases and chitosanase. However, the trend of those genes was less observable in treatments with P-ZD1 and CP-ZD1 nor with ZD1 containing different PHB contents.

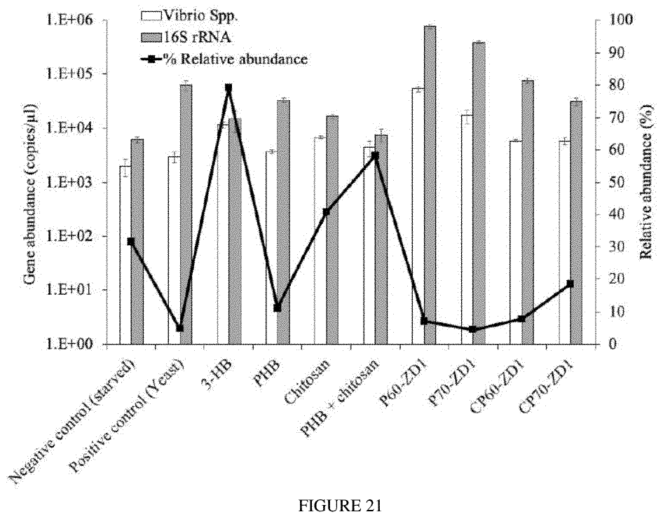

Different antimicrobial properties of the intermediates of PHB and chitosan also played an important role in shaping Artemia's gut microbiome. Generally, a lower abundance of G+ bacteria was observed in Artemia fed with chitosan-containing treatments (i.e., CP-ZD1 and particularly PHB+chitosan) (Table 7 and FIG. 11). Also, lower abundance of G− bacteria and the absence of Vibrionales-associated populations, such as Vibrio (the most common aquaculture pathogen) was observed in Artemia receiving PHB-containing supplements (FIG. 16B and FIG. 21). Overall, the improvements in microbial diversity, presence of beneficial bacteria, and reduction of Vibrionales in Artemia fed with CP-ZD1 could have led to the enhanced growth and disease resistance against Vibrio in our previous results.

### Example 12

### Exemplary Experimental Procedures

The instant example provides exemplary materials and methods utilized in Examples 13-17 as described herein.

Bacterial Strains, Chemicals, and Artemia. Two PHA-accumulating strains, Z denitrificans ZD1 (JCM 13380) and P. oleovorans (ATCC 29347), were obtained from the Japan Collection of Microorganisms and the American Type Culture Collection, respectively. Three known aquaculture pathogens, Vibrio campbellii (DSMZ-German Collection of Microorganisms and Cell Cultures GmbH, DSM 19270) (G− strain), Aeromonas hydrophila (G− strain), and Streptococcus agalactiae (G+ strain), were used. A. hydrophila and S. agalactiae were isolated from diseased fish during an outbreak.

Two SCFAs (butyrate (C-4) and valerate (C-5)), two MCFAs (hexanoate (C-6) and octanoate (C-8)), crystalline PHB, poly(3-hydroxybutyrate-co-3-hydroxyvalerate; PHB:9% w/w HV) (PHB-PHV), and poly(3-HB-co-3-HV-co-3-hydroxyhexanoate; PHB: 2.3% (w/w) HV: 4.1% (w/w) HH) (PHB-PHV-PHH) were purchased from Sigma-Aldrich, USA. High-quality hatching cysts of brine shrimp (Artemia franciscana, EG® Type) for the challenge tests were obtained from INVE Aquaculture, Great Salt Lake, Utah, USA. Artemia is a filter-feeding species used as live food in aquaculture and successfully tested for PHB application. Gnotobiotic Artemia nauplii were hatched and prepared. After 30 hours of incubation, hatched Artemia instar II nauplii were harvested, washed with FASW, and used for all Artemia challenge test.

Sources and Pretreatment of Agro-Industrial Wastes/Wastewaters. Eight different agro-industrial wastes/wastewaters—sugary waste slurry (SWS), cheese whey wastewater (CWW), synthetic crude glycerol (SCG), high-strength synthetic wastewater (HSSW), food waste fermentation liquid (FWFL), banana peels (BP), orange peels (OP), and anchovy fishmeal wastewater (AFWW)—were used as substrates (C-sources) to evaluate the growth of strain ZD1 and determine their potential influences on PHA composition. SWS, collected from a local sweat factory (preferred to stay anonymous) in College Station, Tex., was initially dissolved in DI water and filtered (0.45-μm) before its supplementation to the cultivation medium described in the following section. CWW, containing the last remnant from ricotta cheese production, was prepared as described previously. SCG (15 g/L glycerol) and HSSW (8.2 g/L sodium acetate and 10.1 g/L glucose) were prepared as described previously. FWFL, BP, OP, and AFWW were also prepared as described previously with some modifications. Detailed descriptions of these pretreatments and the physicochemical properties (such as chemical oxygen demand (COD), total nitrogen (TN), salinity, and pH) of agro-industrial wastes/wastewaters are provided in Table 8.

TABLE 8
Characteristic of agro-industrial wastes/wastewaters used
to cultivate Z. denitrificans ZD1 for PHA accumulation.

| Organic Waste | COD (g/L) | TN (g-N/L) | Salinity (g/L) | pH |
|---|---|---|---|---|
| SWS | N.A. [symbol] | — | — | — |
| CWW | 50.4 | 1.47 | 0 | 6.5 |
| SCG | 18.3 | 0.26 | 30 | 7.5 |
| HSSW | 18.3 | 0.42 | 30 | 7.5 |
| FWFL | 18.3 | 0.26 | 30 | 7.5 |
| BP | 22.5 | | — | 4.7 |
| OP | 53.2 | | — | 5.4 |
| AFWW | 35.4 | | — | 5.9 |

[symbol]

N.A. = not applicable.
SWS is a solid waste with 1 g of SWS was equivalent to 1 g of COD.
SWS = sugary waste slurry;
CWW = cheese whey wastewater;
SCG = synthetic crude glycerol;
HSSW = high-strength wastewater;
FWFL = food waste fermentation liquid;
BP = banana peels;
OP = orange peels;
AFWW = anchovy fishmeal wastewater [symbol]
indicates data missing or illegible when filed

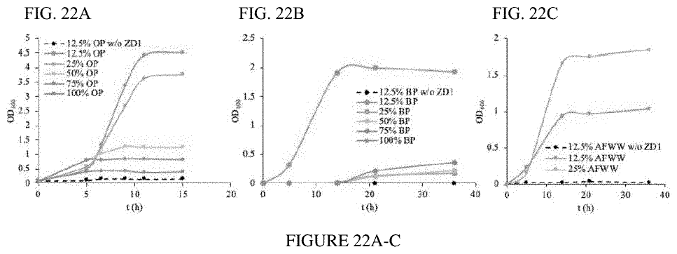

Cultivation of PHA-containing Bacteria with Pure Organic Compounds and Agro-Industrial Wastes/Wastewaters. Strains ZD1 and P. oleovorans were cultured with different C-sources, including pure organic compounds and agro-industrial wastes/wastewaters, to produce a range of SCL-PHA and MCL-PHA for Artemia challenge tests. All of the cultivation experiments were conducted using modified mineral salt medium (MSM) containing NH₄Cl (1 g/L), Na₂HPO₄ (9 g/L), KH₂PO₄ (1.5 g/L), MgSO₄.7H₂O (0.2 g/L), CaCl₂.2H₂O (0.02 g/L), Fe(III)NH₄-citrate (0.0012 g/L), and 0.1% (vol/vol) trace mineral solution. The trace mineral solution contained EDTA (50 g/L), FeCl₃ (8.3 g/L), ZnCl₂ (0.84 g/L), CuCl₂.2H₂O (0.13 g/L), CoCl₂.6H₂O (0.1 g/L), MnCl₂.6H₂O (0.016 g/L), and H₃BO₃ (0.1 g/L). ZD1 growth experiments were conducted in a series of 50 mL MSM supplemented with different C-sources such as sugars (glucose, fructose, sucrose, xylose, and lactose), SCFAs (acetate, propionate, butyrate, and valerate), MCFAs (hexanoate and octanoate), and other pure organics (glycerol and citric acid). In other cultivations sets, agro-industrial wastes/wastewaters (i.e., SWS, CWW, SCG, HSSW, FWFL, BP, OP, and AFWW) were supplemented as C-sources. The initial COD in the cultivation medium was set at 18.3 g/L, except for lactose, BP, OP, and AFWW, which were 8.4, 2.8, 6.6, and 8.8 g/L, respectively, based on preliminary optimization experiments (FIG. 22). LB-grown ZD1 (OD₆₀₀=1.0) after resuspending pellet in MSM was added to the cultivation medium as an inoculum (4% v/v). High salinity (30 g/L NaCl) was used in the cultivation experiments to provide an ideal condition for the nonsterile cultivation of ZD1. For P. oleovorans growth experiments, MCFAs (20 mM of hexanoate and octanoate) were used as C-sources in MSM containing 0.5 g/L NaCl to produce PHH- and PHO-rich P. oleovorans, respectively, as described previously. Reasoner's 2A (R2A)-grown P. oleovorans culture (OD₆₀₀=1) was used as an inoculum. All cultivation flasks were incubated at 30° C. under 150 rpm. Liquid samples were periodically collected to monitor bacterial growth, and samples collected at the stationary growth phase were used to quantify cell dry weight (CDW), COD, TN, pH, COD removal efficiency, and PHA content and composition.

Physicochemical analyses, such as bacterial growth, CDW, cell concentration, COD, and TN, were determined as described before. The PHA-rich biomasses produced from the cultivation experiments (i.e., PHB/V-rich ZD1 and PHH/O-rich P. oleovorans) were used for the Artemia challenge tests described below. Liquid samples were collected at the stationary phase and centrifuged at 4,500×g for 10 minutes at 4° C. The collected pellets were then dried for 24 hours at 105° C. and grounded with pestle and mortar before supplementation to Artemia.

Growth Inhibition Tests: Antipathogenic Properties of SCFAs and MCFAs. Growth inhibition tests to measure optical density (OD₆₀₀) and calculate % inhibition efficiencies, minimum, and median inhibitory concentrations (MIC and IC₅₀) were conducted as described previously. Briefly, a series of 55-mL culture tubes containing 10 mL of Luria-Bertani (LB) medium (pH=6) were inoculated (2% v/v with OD₆₀₀ of 1.0) with one pathogenic strain type and subjected to various concentrations (5-125 mM) of one of these SCL-PHA intermediates (i.e., SCFAs: butyrate and valerate) and MCL-PHAs intermediates (i.e., MCFAs: hexanoate, and octanoate). The PHA intermediates (SCFAs and MCFAs) are water-soluble, representing the PHA degradation products in the gastrointestinal tract of aquatic animals, allowing to assess the antipathogenic efficacy of PHA under the best scenario. The culture tubes were incubated at 30° C. under 150 rpm. The growths of tested strains in the absence of PHA intermediates were used as controls.

Artemia Starvation and Pathogen Challenge Tests. Artemia starvation and pathogen challenge tests were designed to determine the effects of different supplements, from individual chemicals of SCFAs and MCFAs to crystalline SCL- and MCL-PHA, amorphous SCL-PHA-rich SCPs, and MCL-PHA-rich SCPs, on the growth and survival of Artemia with and without experiencing starvation and/or exposure to pathogens. The starvation challenge tests examined whether the individual feeds can be used as an energy/food source for the starved Artemia. Briefly, hatched Artemia nauplii (one day old) were transferred to new sterilized 55-mL glass tubes with 20 mL of filtered autoclaved artificial seawater (FASW) containing 35-g/L sea salt (Instant Ocean, USA) with a stock density of 1 nauplii/mL, followed by one-time feeding of one of the supplements (SCFAs (butyrate and valerate), MCFAs (hexanoate and octanoate), crystalline PHB, crystalline PHB-PHV, crystalline PHB-PHV-PHH, amorphous SCL-PHA (PHB-rich ZD1 and PHV-rich ZD1), and amorphous MCL-PHA (PHH-rich P. oleovorans and PHO-rich P. oleovorans)). Starved (unfed) Artemia and yeast-fed Artemia were used as negative and positive controls, respectively. The culture tubes were placed on a rotor (4 cycles/minute) at room temperature with continuous illumination. The survival of Artemia was monitored daily for four days.

The pathogen challenge tests were designed to determine the effects of individual supplements on the survival of Vibrio-challenged Artemia. The pathogen challenge tests were conducted as described in the starvation tests, except that Artemia cultures (one day old) with each of the abovementioned supplements (1 g/L) were exposed to a lethal dose (10⁸ cells/ml) of live V. campbellii as determined previously. In all treatments, 250 mg/L of yeast was added initially as a feed. Unchallenged and Vibrio-challenged Artemia were used as negative and positive controls, respectively. The survival of Artemia was monitored daily for three days.

Analysis of PHA. The PHA accumulated in ZD1 and P. oleovorans grown on different substrates were extracted with methanolysis (i.e., 2 mL chloroform and 2 mL acidified methanol (15% v/v H₂SO₄)) as described before, and then the composition and concentration were determined using a gas chromatography-flame ionization detector, GC-FID (Model 6890N, Agilent, USA) equipped with a DuraGuard J&W DB-5MS column (30 m, 0.25 mm, 0.25 μm). Briefly, 30 mg of dried bacterial biomass was subjected to methanolysis in a screw-cap glass tube by reacting with 2 mL chloroform and 2 mL acidified methanol in a heating block at 100° C. for 4 h. After cooling, 1 mL of DI water was added, and the mixture was vigorously shaken to separate and collect the bottom organic phase. One microliter of the 0.2-μm filtered organic phase was injected automatically into the GC-FID operating at the following oven program: initial temperature at 80° C. for 4 minutes, followed by the first temperature ramp of 8° C./minute to 160° C. and then hold for 6 minutes, and the second temperature ramp of 25° C./minute to 200° C. and then hold for 1 minute. Helium was the carrier gas of 1.2 mL/minute. The injector and detector temperatures were 250° C. and 280° C., respectively. The PHA mass was calculated by comparing peak areas to a calibration curve using crystalline PHB, PHB-PHV, and PHB—PHV-PHH (Sigma-Aldrich, USA). To determine the calibration curves, pure PHA monomers in ranges between 0.1 mg and 1 mg were used as standards and subjected to the treatment described above. The PHA content was determined as the weight of PHA/CDW.

### Example 13

### ZD1 Produced Different Chain-Length PHA from Different Organic Compounds

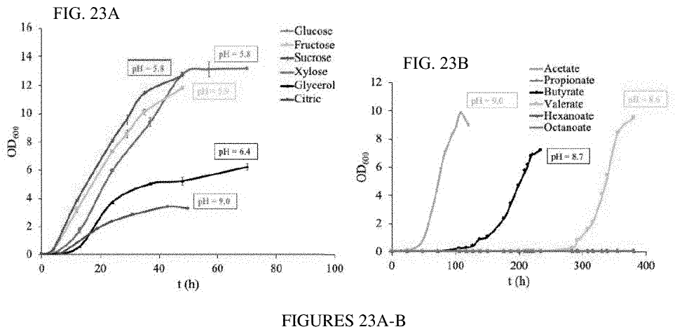

Strain ZD1 could grow on all the tested pure organic compounds (e.g., sugars, SCFAs, MCFAs, and other organics, except xylose), and also accumulate different PHA. ZD1 grew at a similar rate when using glucose, fructose, sucrose, and lactose, but slightly slower when grown on glycerol and citric acid (FIG. 23A). ZD1 also reached higher cell densities when using sugars (OD₆₀₀=12-14; CDW=3-3.4 g/L), followed by using glycerol (OD₆₀₀=6; CDW=2 g/L) and citric acid (OD₆₀₀=3.5; CDW=1.2 g/L) (panel A in Table 9). ZD1 also grew on SCFAs such as acetate, butyrate, and valerate to reach OD₆₀₀ of 8-10. However, ZD1 was unable to grow on propionate, hexanoate, or octanoate (FIG. 23B). While ZD1 would reach a cell concentration of 1.8-2.5 g/L when using SCFAs (panel A in Table 9), a much longer lag phase was observed when the cells were cultivated with long carbon chain-length fatty acids (e.g., 290 hours for C-5 valerate>120 hours for C-4 butyrate>37 hours for C-2 acetate) (FIG. 23B).

TABLE 9
Growth of ZD1 and PHA accumulation from different pure
organic substrates and agro-industrial wastes/wastewaters.

| | | | | | | | | | | |
|---|---|---|---|---|---|---|---|---|---|---|
| | | | | | | | PHA | | | Yield |
| | | | | | | | produc- | | % | (g PHA/ |
| Carbon | Incubation | CDW | % | % | % | PHA | tivity | Final | COD | g COD |
| Source | time (h) | (g/L) | PHA [symbol] | HB | HV | (g/L) | (g/L) | pH | Removal | consumed) |

Panel A: ZD1 growth and PHA accumulation in pure organic compounds as carbon sources

| | | | | | | | | | | |
|---|---|---|---|---|---|---|---|---|---|---|
| Glucose | 37 | 3.40 | 63.32 | 63.07 | 0.24 | 2.16 | 0.91 | 5.8 | 59.2 | 0.20 |
| Fructose | 48 | 3.08 | 66.89 | 66.61 | 0.28 | 2.06 | 1.03 | 5.9 | 60.9 | 0.19 |
| Sucrose | 48 | 3.16 | [symbol] | [symbol] | 0.23 | 1.73 | 0.87 | 5.8 | [symbol] | 0.17 |
| Xylose | — | — | — | — | — | — | — | — | — | — |
| Lactose | 247 | 0.72 | 0.81 | — | [symbol] | 0.01 | 0.00 | 6.8 | 50.3 | 0.00 |
| Glycerol | 48 | 1.98 | 32.29 | 31.88 | 0.41 | [symbol] | 0.32 | 6.4 | 26.2 | 0.13 |
| Citric | 60 | 1.22 | 25.79 | 25.15 | 0.64 | 0.32 | [symbol] | 9 | 78 | 0.02 |
| Acetate | 120 | 2.48 | [symbol] | 59.10 | 0.29 | 1.47 | 0.29 | 9 | 18.2 | 0.44 |
| Propionate | — | — | — | — | — | — | — | — | — | — |
| Butyrate | 222 | 1.84 | 60.40 | 60.07 | 0.33 | 1.11 | 0.32 | 8.7 | [symbol] | 0.38 |
| Valerate | 380 | 2.34 | 32.04 | 1.41 | [symbol] | 1.22 | 0.08 | 8.6 | 20.7 | 0.32 |
| Hezanonate | — | — | — | — | — | — | — | — | — | — |
| Octanoate | — | — | — | — | — | — | — | — | — | — |

Panel B: ZD1 growth and PHA accumulation in agro-industrial wastes/wasterwaters as carbon sources

| | | | | | | | | | | |
|---|---|---|---|---|---|---|---|---|---|---|
| SWS | 69 | 2.81 | 65.60 | 63.18 | 0.42 | 1.85 | 0.64 | 5.9 | 30.1 | 6.34 |
| CWW | 20 | 1.55 | 13.29 | 12.90 | 0.39 | 0.21 | 0.25 | 6.5 | 31.5 | 0.00 |
| SCG | 43 | 1.72 | 29.81 | 29.26 | 0.35 | 0.51 | 0.29 | 6.6 | 18.3 | 0.14 |
| BSSW | 43 | 0.15 | 49.41 | 49.43 | 0.00 | 0.07 | 0.84 | 6.1 | 12.7 | 0.03 |
| FWFL | 65 | 1.11 | 17.50 | 14.78 | 2.72 | 0.19 | 0.07 | 8.6 | 24.8 | 0.04 |
| BP | 16 | 0.70 | 0.75 | — | 0.75 | 0.01 | 0.01 | 6.9 | 25.7 | 0.02 |
| OP | 22 | 1.75 | 25.59 | 25.00 | 0.59 | 0.45 | 0.49 | 6.6 | 28.2 | 0.24 |
| AFWW | 16 | 0.66 | 0.59 | — | 0.59 | 0.01 | 0.01 | 7.3 | 15.5 | 0.01 |

[symbol]

The percentage of the PHA content in the cell dry weight (CDW) after reaching the stationary growth phase. SWS = sugary waste slurry; CWW = cheese whey wastewater; SCG = synthetic crude glycerol; HSSW = high-strength wastewater; FWFL = food waste fermentation liquid; BP = banana peels; OP = orange peels; AFWW = [symbol] fishmeal wastewater. [symbol]
indicates data missing or illegible when filed

The rapid growth of ZD1 to high cell densities when using sugars, and the slower growth when cultivated with reduced fatty acids were expected. However, the inability of ZD1 to grow on xylose, despite the presence of genes encoding xylose isomerase, and D-xylose ABC transporter ATP-binding protein in the genome of ZD1, was unclear. In contrast, the successful growth of ZD1 on SCFAs (i.e., acetate, butyrate, and valerate) indicated that the strain could contain genes encoding enzymes to utilize those fatty acids. However, as the carbon chain-length increases (>5C), the fatty acid becomes more difficult to assimilate. This was confirmed by ZD1 incapability to grow on MCFAs and/or the elongated lag phase observed with longer SCFAs. However, without being bound by any theory, the inability of ZD1 to grow on propionate could be related to its cell-damaging effects due to odd and short n-alkyl-carbon-chain fatty acids (i.e., C-3). Previous studies have reported the inhibition effects of propionate on the growth and PHA accumulation when used as a (co)-substrate for Z. denitrificans MW1 and Ralstonia eutropha.

The highest PHA accumulations in ZD1 were observed with sugars, particularly in glucose and fructose (63-67% gPHA/gCDW), followed by 52-60% in SCFAs (acetate, butyrate, and valerate), and 25-32% in glycerol and citric acid (panel A in Table 9). Most importantly, the main polymer composition of the accumulated PHA was the HB monomer unit with a small fraction of the HV unit (<1%). Notably, valerate-grown ZD1 biomass contained 52% HV along with <2% HB (panel A in Table 9). The initial pH in sugars-supplied mediums dropped from 7.5 to 5.8 as ZD1 grew, while it raised to 8.6-9 in mediums containing acids (panel A in Table 1). Moreover, a high COD removal efficiency (78%) was observed in citric acid, followed by sugars (55-60%), and then fatty acids (15-20%) (panel A in Table 9).

Without being bound by any theory, the high PHA accumulation in ZD1 grown on sugars and fatty acids compared with other organics (glycerol and citric acid) could be related to the PHA biosynthesis pathways determined for sugars and fatty acids. However, the primary accumulation of SCL-PHA in ZD1 (i.e., mainly PHB with a small fraction of PHV regardless of the C-source) could indicate the PHA synthases in ZD1 are unable to synthesize MCL-PHA, as ZD1 was unable to grow on medium-chain aliphatic compounds like hexane or octane as observed in this study. These results indicated that the PHA synthesis in ZD1 is not limited to produce PHB as PHV was simultaneously synthesized. The biosynthesis of SCL-PHA can take two pathways. Pathway I, related to sugars, starts with the condensation of two molecules of acetyl-CoA to acetoacetyl-CoA by 3-ketothiolase (PhaA), which is then reduced to 3-hydroxybutyryl-CoA by acetoacetyl-CoA reductase (PhaB) using NADPH as the electron donor. Finally, 3-hydroxybutyryl-CoA is polymerized to PHB by PHA synthase (PhaC class I). The 3HV monomer units could be synthesized by adding propionate or valerate to the cultivation medium, causing the condensation of propionyl-CoA and acetyl-CoA by the action of 3-ketothiolase to 3-ketovaleryl-CoA. The 3HV units could also be synthesized by pathway II, which involves the degradation of fatty acids via β-oxidation to generate substrates that can be polymerized by PHA synthase yielding SCL-PHA copolymer, mainly PHBV. Nevertheless, some microorganisms can generate the key precursor of 3HV-CoA for PHBV biosynthesis from unrelated C-sources. Interestingly, without being bound by any theory, the high HV accumulation in valerate-grown ZD1 suggests that pathway II could be the major PHA biosynthesis pathway for fatty acids, and that HB and HV accumulation could be related to the strain's capability to grow on butyrate and valerate, respectively (FIG. 23B).

Finally, the drop in pH value in sugars-supplied mediums is due to the secretion of acids and release of protons (H⁺) during the oxidation of the energy source (sugars) and vice versa (i.e., protons consumption in acids-supplied mediums). However, based on the remaining COD in all mediums, it is possible that high PHA-rich ZD1 biomass production could be achieved by controlling pH and supplying additional N. Overall, the broad spectrum of substrates exploitation and high PHA accumulation demonstrated the remarkable potential of ZD1 to treat various agro-industrial wastes/wastewaters, particularly sugars-containing wastes while accumulating relatively inexpensive and tailor-made PHA co-/polymers.

### Example 14

### ZD1 Produced Different Chain-Length PHA from Different Agro-Industrial Wastes/Wastewaters

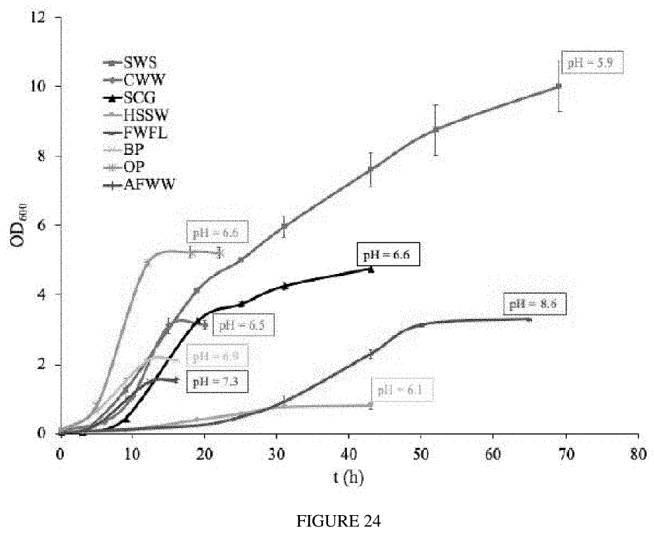

Variation in chemical compositions of agro-industrial wastes/wastewaters may or may not be used for ZD1 cultivation and PHB accumulation, as organic wastes might potentially contain inhibitory compounds or not readily biodegradable contents. FIG. 24 and Table 9 (panel B) show that ZD1 was able to grow on various real and synthetic agro-industrial wastes/wastewaters and accumulate different levels and chain-length of PHA, reaching CDW (shown in parenthesis) from high to low: SWS (2.81 g/L)>OP=SCG (1.75 g/L)>CWW (1.55 g/L)>FWFL (1.11 g/L)>BP=AFWW (0.7 g/L)>HSSW (0.15 g/L). Interestingly, PHA contents in ZD1 biomass were comparable to those accumulated in ZD1 grown in simple, pure organic compounds in the previous section, with a maximum PHA accumulation of 65% observed in SWS (panel B in Table 9). However, no significant PHA accumulation (<1%) was observed in ZD1 grown on BP and AFWW. As noted with pure organic compounds, the PHA polymer composition in ZD1 was mainly HB monomer unit along with <1% HV unit. Notably, ZD1 grown on FWFL contained a larger fraction of HV unit (3%) along with 14.8% HB. Likewise, following the ZD1 growth, the pH in all cultivation media dropped to 5.9-6.5, except in FWFL, which increased to 8.6 (panel B in Table 9).

The ability of ZD1 to grow rapidly on non-sterile agro-industrial wastes/wastewater while producing high levels of different chain-length PHA is highly favorable, placing strain ZD1 as an ideal candidate among the previously tested PHA-accumulating strains as single-cell proteins. Without being bound by any theory, the fast growth of ZD1 grown in all wastes, except for BP (banana peels) and AFWW (anchovy fishmeal wastewater), could be attributed to more readily biodegradable organics for growth and biomass production. On the other hand, BP and AFWW contain more undegradable contents such as lignocellulose, which are complex and typically require pretreatment to release useful sugars in the lignocellulose. Strain ZD1 produced mainly PHB with a trace amount of PHV when grown with all tested agro-industrial wastes, except for those grown with FWFL that contains a higher level of valeric acid (i.e., 11% COD-based), suggesting that the addition of valeric acid in organic wastes could promote the accumulation of PHV along with PHB. While only a trace level of PHV was observed in ZD1, this HV could promote the polymer properties (i.e., better thermal and mechanical properties than PHB alone). Most importantly, without being bound by any theory, it could deliver stronger antimicrobial activities due to the presence of longer SCFAs, thereby improving biocontrol efficacy against aquaculture pathogens. Overall, the efficient ZD1 growth and PHA accumulation observed with different agro-industrial wastes/wastewaters demonstrate ZD1 could be utilized to exploit various wastes while producing PHA-rich SCPs for different applications, including biocontrol agents for aquaculture.

### Example 15

### Antipathogenic Properties of SCL- and MCL-PHA Intermediates

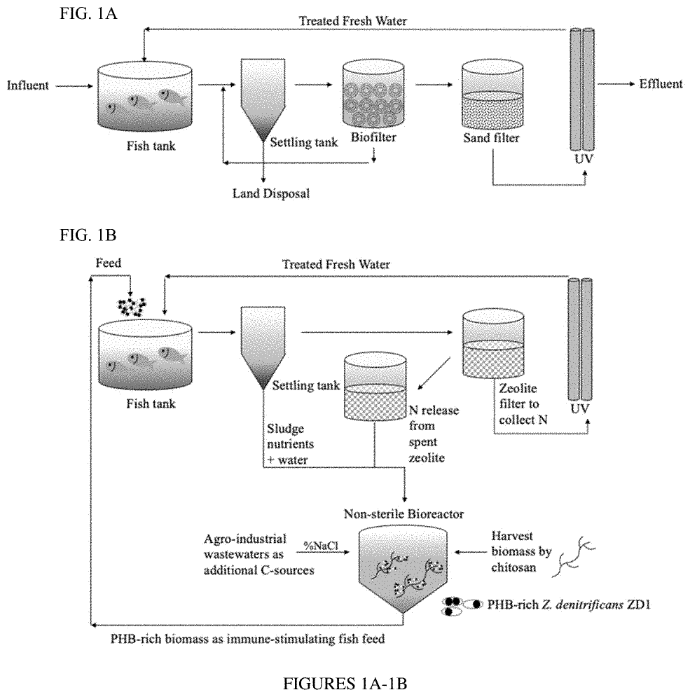

Effects of SCFAs and MCFAs on the Growth of G− and G+ Pathogens. Growth inhibition of common G− and G+ aquaculture pathogens was observed in the presence of SCL- and MCL-PHA intermediates such as SCFAs (butyrate and valerate) and MCFAs (hexanoate and octanoate). All SCFAs and MCFAs inhibited the growth of tested pathogens (V. campbellii, A. hydrophila, and S. agalactiae) in a concentration-dependent manner (FIG. 1). Additionally, higher inhibitory effects were observed when pathogens were exposed to longer chain-length of fatty acids, i.e., more pronounced with MCFAs (hexanoate and octanoate) than SCFAs (butyrate and valerate).

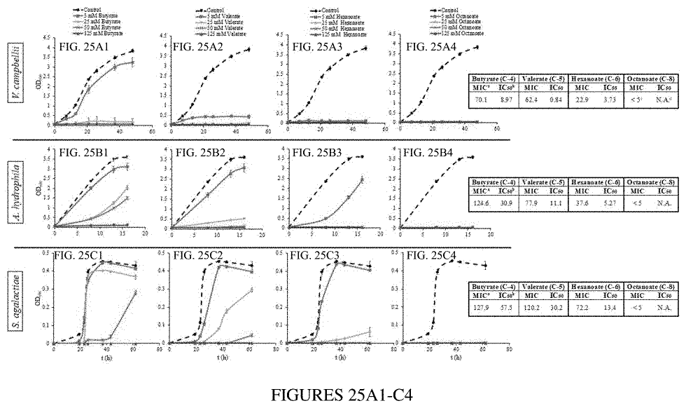

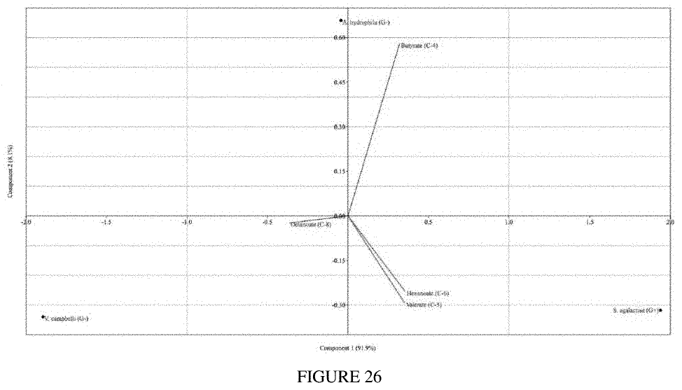

All SCFAs and MCFAs were effective against the aquaculture pathogens, particularly against G− strains (V. campbellii and A. hydrophila) with less inhibitory concentrations compared to G+ S. agalactiae (inset tables in FIG. 25). However, SCFAs were less effective (butyrate<valerate<hexanoate<octanoate) and required higher concentrations compared to MCFAs to inhibit pathogenic growth. For instance, MICs of 70.1-124.6 mM butyrate and 62.4-77.9 mM valerate were required to inhibit V. campbellii and A. hydrophila, while only 22.9-37.6 mM hexanoate and <5 mM of octanoate were sufficient (inset tables in FIG. 25). Furthermore, the IC₅₀ occurred at 8.97-30.9 mM butyrate and 0.84-11.1 mM valerate for V. campbellii and A. hydrophila, while S. agalactiae was slightly more tolerant, requiring higher IC₅₀ (57.5 mM butyrate and 30.2 mM valerate). Octanoate was the most effective fatty acid against all pathogenic growth with a MIC of <5 mM. Similarly, the biplot based on the highest optical densities revealed that aquaculture pathogens were highly susceptible to the chain-length of fatty acids: octanoate>hexanoate>valerate>butyrate (FIG. 26). Specifically, G− pathogenic strains were more sensitive, i.e., located far from the PHA intermediates, whereas S. agalactiae was less suspectable (i.e., located closer to PHA intermediates).

Antipathogenic Properties of SCFAs and MCFAs. This study was the first to demonstrate that MCFAs were more effective than SCFAs in inhibiting the growth of common G− and G+ aquaculture pathogens. The observed inhibitory impacts of SCFAs were consistent with those reported in the literature that SCFAs such as formic, acetic, propionic, valeric, and particularly butyric acid, were effective against various enterobacteria, supporting the application of SCL-PHA as biocontrol agents in aquaculture. However, without being bound by any theory, the higher antipathogenic efficacy of MCFAs (hexanoate and octanoate) compared to SCFAs could be attributed to the carbon chain-length. The increase in carbon atoms in the compound elevates complexity and molecular weight, which could interfere with cell metabolism and eventually lead to cell inactivation.

Although the exact underlying mechanism of PHA intermediates against pathogens is unknown, one hypothesis maintains that fatty acids diffuse through the cell membrane and release protons (H⁺) from their undissociated forms to lower the cytoplasm's pH. Consequently, the pathogens have to redirect their cellular energy to maintain homeostasis, suppressing their growth and causing cell death. Nevertheless, without being bound by any theory, the stronger antipathogenic activity of PHA intermediates against G− strains (e.g., V. campbellii and A. hydrophila) could be attributed to the higher diffusion of the intermediates through the thin peptidoglycan layer of G− cell wall, while hindered by the thick peptidoglycan layer of G+ strains. This observation was also consistent with a previous study that demonstrated stronger antipathogenic activity of PHB intermediates/SCFAs (3-HB and butyrate) against G− strains than G+ strains. Overall, these results could suggest that PHA intermediates, particularly MCFAs, can be usitlized against pathogens and could serve as promising biocontrol agents to promote survival and disease resistance in aquaculture. Therefore, without being bound by any theory, an effective strategy to combat pathogens in aquaculture could be by delivering PHA intermediates efficiently through PHA-accumulating SCPs like ZD1 and P. oleovorans to aquatic animals.

### Example 16

### SCL- and MCL-PHA-Rich SCPs Served as Food/Energy Sources for Artemia

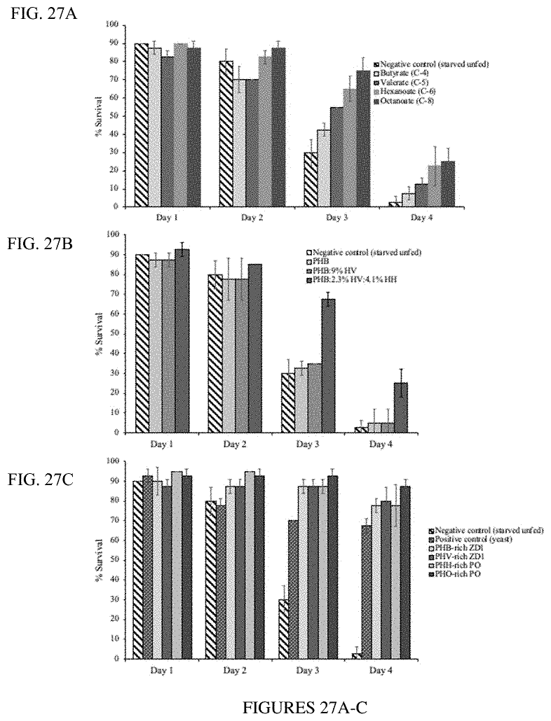

The ability of starved Artemia to use supplements such as SCFAs, MCFAs, crystalline PHA (co)-polymers, and amorphous PHA-rich SCPs as food/energy sources was examined After four days of incubation, only 2.5% survival was observed in the negative controls (i.e., starved unfed Artemia) and 67.5% in the positive controls (i.e., yeast-fed Artemia) (FIG. 2). Feeding Artemia with individual fatty acids, particularly MCFAs (hexanoate and octanoate), improved the survival of the starved Artemia to 22.5-25% (FIG. 27A). Interestingly, a proportional relationship between the carbon chain-group and the survival was observed (i.e., octanoate>hexanoate>valerate>butyrate). On the other hand, feeding crystalline SCL-PHA (e.g., PHB or PHB-PHV) did not significantly improve the survival of starved Artemia (FIG. 27B). However, feeding crystalline MCL-PHA (e.g., PHB-PHV-PHH) prolonged the survival to 25%. Most importantly, feeding PHA-rich SCPs (i.e., PHB-rich ZD1 (60.1% PHB+0.3% PHV), PHV-rich ZD1 (1.4% PHB+50.6% PHV), PHH-rich P. oleovorans (1.9% PHH), PHO-rich P. oleovorans (2.1% PHH+25.6% PHO) significantly improved the survival of starved Artemia to 77.5-87.5%, which is even higher than the yeast-fed Artemia (FIG. 27C). However, an insignificant difference in survival was observed between feeding different PHA-rich SCPs. Notably, by visualizing Artemia with a 30× glass magnifier, Artemia fed with PHA-rich SCPs clearly had an advanced nauplii life stage (e.g., grew larger, moved faster, and developed rudimentary thoracopods and bilateral compound eyes).

The higher survival of starved fatty acid-supplied Artemia suggested that fatty acids, particularly MCFAs, could serve as energy sources for Artemia. Previous studies have shown that SCFAs (e.g., 3-HB and butyrate) could provide energy for Artemia. Without being bound by any theory, the enhanced survival with feeding MCFAs (hexanoate and octanoate) could be attributed to their longer carbon chain-length (i.e., >5C), thus sustaining the survival by providing extra energy. This could also be explained by the property of SCFAs and MCFAs being important substrates for the energy metabolism and anabolic processes, which could be further used as blood fuel for energy purposes or lipid synthesis by aquatic animals.

Feeding pure crystalline PHA co-/polymers suggested no adverse effects on Artemia. In fact, PHA with longer chain-length monomers (i.e., PHB-PHV-PHH) significantly prolonged the survival of Artemia, consistent with feeding pure MCFAs described above. Previous studies have shown that pure crystalline PHB can serve as an additional energy source for starved Artemia. Furthermore, replacing 0.1-5% (w/w) of the standard diet with PHB-PHH (11%) improved the survival of Kuruma shrimp without affecting body weight, feeding rate, and feed conversion ratio. Those findings further confirmed the potential of PHA, particularly with longer monomers, to provide energy (in terms of lipid deposition) to aquatic animals. The lipid-saving effects of PHA (e.g., PHB) have been previously confirmed with Artemia and Nile tilapia, reporting higher lipid and whole-body contents.

The enhanced Artemia survivals after feeding PHA-rich SCPs were promising. However, without being bound by any theory, the insignificant survival between feeding different chain-length PHA-rich SCPs could be attributed to the biomass content. ZD1 and P. oleovorans are PHA-accumulating microorganisms that contain essential nutrients (e.g., proteins, lipids, and minerals), which can contribute energy for Artemia. Therefore, other cell components could have overshadowed the distinctive impacts of different accumulated PHA in the biomass. Nevertheless, the high survival of starved Artemia when supplied with ZD1 and P. oleovorans than with yeast could be attributed to bacteria's simple and more digestible cell wall compared to yeasts' cell wall, which is characterized to be rough (i.e., comprises 25-30% of dry matter) with complex heteropolysaccharides, mannoprotein, and glucan, all of which complicate yeast's digestibility. Overall, the Artemia starvation results indicated that PHA-rich SCPs can be easily assimilated (degraded in the gut) and can be utilized as effective food/energy sources by aquatic animals.

### Example 17

### Effectiveness of SCL- and MCL-PHA-Rich SCPs on the Survival of Vibrio-Challenged Artemia

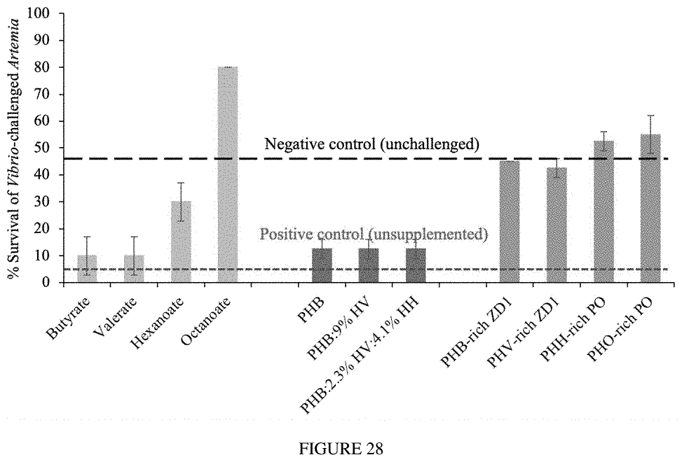

The effects of different supplements (i.e., SCFAs, MCFAs, crystalline PHA co-polymers, PHB-rich ZD1 (60.1% PHB+0.3% PHV), PHV-rich ZD1 (1.4% PHB+50.6% PHV), PHH-rich P. oleovorans (1.9% PHH), PHO-rich P. oleovorans (2.1% PHH+25.6% PHO)) on the survival of Vibrio-challenged yeast-pre-grown Artemia are shown in FIG. 28. The survival rates of the positive controls (i.e., unsupplemented Vibrio-challenged Artemia) and negative controls (i.e., unchallenged Artemia) after three days were 5% and 47.5%, respectively. The survival from low to high was as follows: 10% for butyrate- and valerate-supplemented Artemia<12.5% for crystalline PHA co-/polymers-supplemented Artemia (i.e., PHB, PHB-PHV, and PHB-PHV-PHH)<30% for hexanoate-supplemented Artemia<42.5-55% for PHB/V-rich ZD1-supplemented Artemia<55% for PHH/O-rich P. oleovorans-supplemented Artemia<80% for octanoate-supplemented Artemia (FIG. 28).

The results of the pathogen challenge experiments indicated that the longer the carbon chain-length PHA, particularly the MCL-PHA-rich SCPs, the better survival of the Artemia against pathogenic Vibrio. Previous studies have confirmed that SCL-PHA (e.g., PHB and PHBV) promotes the survival and disease resistance of aquaculture animals, including Artemia. When PHB was ingested, it could be subjected to partial conversion into SCFAs (3-HB and butyrate monomers and oligomers) by digestive enzymes or PHB degraders in the animal gut. Studies have indeed documented the release of 3-HB in Artemia's gut after feeding with varying levels of PHB. The release of SCFAs such as 3-HB may reduce Vibrio's motility that was mediated by flagella and pili adhesion factors, and inhibited expression of bioluminescence, hemolysin, and quorum-sensing compounds that led to disruption of biofilm formation. Another protective mechanism of PHB is stimulating stress- and immune-response in Artemia, particularly the innate (non-specific) genes. This mechanism is associated with the cellular acidification induced by 3-HB release in the animal gut, leading to a higher expression of defensive genes.

Without being bound by any theory, the enhanced Artemia survival in response to supplementing with longer MCL-PHA (i.e., PHH/O-rich P. oleovorans) (FIG. 28) could be attributed to the higher number of carbons (>5C) in PHA that inhibited the growth of Vibrio as observed in this study with lower MIC and IC₅₀ of MCFAs to inhibit V. campbellii as listed in the inset tables in FIG. 25. The ability of Artemia to use pure octanoate and/or PHO-rich P. oleovorans (FIG. 25) further signifies the greater antipathogenic activity of longer PHA, in part, might be due to the release of MCFAs intermediates in the gut of Artemia. Consistent with the findings of this study, caprylic acid (also known as octanoic acid) was shown to promote the survival of challenged Artemia and inhibit shrimp pathogens (V. harveyi and V. parahaemolyticus) and even fish parasites. Octanoic acid (C-8) is longer than SCFAs and less hydrophobic (i.e., more soluble) than long-chain fatty acids, thereby more effective in killing bacteria. Moreover, it was reported that supplementing PHB-PHH (11%) extracted from recombinant Cupriavidus necator increased the survival of Kuruma shrimp challenged with V. penaeicida, and that the in vitro supplementation of 3-HH had a greater antibacterial effect than 3-HB. Another study reported that supplementing PHBV extracted from Bacillus thuringiensis enhanced disease resistance of Mozambique tilapia challenged with A. hydrophila.

Despite the benefits of supplementing PHA, the survival of Vibrio-challenged Artemia when using crystalline PHA was lower than that using amorphous PHA-rich SCPs. Without being bound by any theory, this observation could be attributed to smaller particle size and lower crystallinity in amorphous PHA, making it more susceptible to enzymatic and microbial degradation. Moreover, crystalline PHA lack other cell nutrients (e.g., proteins, lipids, and minerals) found in amorphous PHA, which might have elicited additional immune responses. Few studies have applied amorphous PHA-accumulating SCPs to aquafeeds such as Alcaligenes eutrophus, Halomonas spp., Brevibacterium casei, Bacillus sp., Comamonas testosteroni, and Brachymonas denitrificans. The advantage of using ZD1 is that it can accumulate PHB/V in a growth-associated manner (i.e., without nutrient limitation), allowing a simple and continuous single-stage production bioprocess. Furthermore, ZD1 with a common osmolyte (ectoine) eliminates the need for energy-intensive sterilization by growing in high salt concentration (30 g/L); thus, inhibiting the growth of non-salt-tolerant. P. oleovorans is another important SCP traditionally used to accumulate MCL-PHA such as PHH and PHO. Therefore, the application of P. oleovorans with MCL-PHA provided additional biocontrol benefits to aquatic animals.

Overall, PHA-rich ZD1 and P. oleovorans demonstrated protection of Artemia against the Vibrio infection. The example investigated the application of PHA-rich ZD1 and P. oleovorans in aquaculture. Most importantly, the example also compared the biocontrol potential of various types and forms of SCL- and MCL-PHA (i.e., intermediates, crystalline, and amorphous PHA-rich SCPs) in aquaculture.

What is claimed is:

1. A recirculating aquaculture system comprising a) a wastewater treatment system and b) a polyhydroxyalkanoate (PHA) production system.

2. The recirculating aquaculture system of claim 1, wherein the PHA comprises short chain-length (SCL) hydroxyl fatty acids.

3. The recirculating aquaculture system of claim 1, wherein the PHA comprises medium chain-length (MCL) hydroxyl fatty acids.

4. The recirculating aquaculture system of claim 1, wherein the PHA is poly(3-hydroxybutyrate) (PHB).

5. The recirculating aquaculture system of claim 1, wherein the wastewater treatment system is configured for contacting wastewater with one or more zeolites to remove material from the wastewater and reusing the treated wastewater.

6. The recirculating aquaculture system of claim 1, wherein the PHA production system comprises combining i) organic waste, ii) wastewater, or iii) a combination of both with a bacterial strain.

7. The recirculating aquaculture system of claim 6, wherein the bacterial strain is a Zobellella denitrificans ZD1 strain.

8. The recirculating aquaculture system of claim 6, wherein the method further comprises a step of harvesting the cultured bacterial strain comprising PHA via chitosan.

9. A method of treating wastewater for reuse, said method comprising the step of contacting the wastewater with one or more zeolites to remove material from the wastewater and reusing the treated wastewater.

10. The method of claim 9, wherein the zeolite adsorbs the removed material.

11. The method of claim 9, wherein the removed material is utilized via culturing a Zobellella denitrificans ZD1 strain.

12. The method of claim 9, wherein the ZD1 strain produces a polyhydroxyalkanoate (PHA), wherein the PHA is PHB.

13. A method of producing a polyhydroxyalkanoate (PHA) from organic waste, said method comprising the step of combining the organic waste with a bacterial strain and culturing the bacterial strain under salt conditions, wherein the cultured bacterial strain produces the PHA.

14. The method of claim 13, wherein the PHA is poly(3-hydroxybutyrate) (PHB).

15. The method of claim 13, wherein the PHA comprises repeating units of a SCL hydroxyl fatty acid, a MCL hydroxyl fatty acid, or a combination thereof.

16. The method of claim 13, wherein the bacterial strain is a Zobellella denitrificans ZD1 strain.

17. The method of claim 13, wherein the organic waste is selected from the group consisting of wastewater, glycerol, activated sludge, and any combination thereof.

18. The method of claim 13, wherein the method further comprises a step of harvesting the cultured bacterial strain comprising PHA via chitosan.

19. The method of claim 18, wherein the bacterial strain is a Zobellella denitrificans ZD1 strain.

20. The method of claim 18, wherein the PHA is PHB.
